(19) United States
(12) Patent Application Publication
(10) Pub. No.: US 2014/0016458 A1
(43) Pub. Date: Jan. 16, 2014

(54) ROUTER APPARATUS AND LINE SWITCHING METHOD IN ROUTER APPARATUS

(71) Applicant: FUJITSU LIMITED, Kawasaki-shi (JP)

(72) Inventor: Haruo MORITOMO, Fuchuu (JP)

(73) Assignee: FUJITSU LIMITED, Kawasaki-shi (JP)

(21) Appl. No.: 14/027,861

(22) Filed: Sep. 16, 2013

Related U.S. Application Data
(63) Continuation of application No. PCT/JP2011/056360, filed on Mar. 17, 2011.

(51) Int. Cl. H04L 12/24

(52) U.S. Cl. CPC H04L 41/0654
USPC 370/225

(57) ABSTRACT

A router apparatus for performing communication by switching a first and second line, the router apparatus includes: a setting unit which sets a first protection time until the first line is switched to the second line after a line failure in the first line is detected, and a second protection time until the second line is switched to the first line after recovery from the line failure in the first line is detected, to times corresponding to a quality state of the first line, respectively; and a line switching unit which switches the first line to the second line when the first protection time elapses and the line failure in the first line continues, or switches the second line to the first line when the second protection time elapses after the line failure in the first line is detected.

### CROSS-REFERENCE TO RELATED APPLICATION

This application is a continuation application of International Application PCT/JP2011/056360 filed on Mar. 17, 2011 and designated the U.S., the entire contents of which are incorporated herein by reference.

### FIELD

The embodiments discussed herein are related to a router apparatus and a line switching method in the router apparatus.

### BACKGROUND

Recently, as a WAN (Wide Area Network) line, a wireless WAN line is employed. This is why it can be performed high-speed radio broadband communication even by the wireless WAN line as compared with a conventional wireless WAN line. However, the wireless WAN line may have a radio characteristic that is affected by a usage environment, radio environment, etc. For example, the communication speed may be reduced as compared with the usual case, and the communication line may be disconnected suddenly. Therefore, the wireless WAN line is not used as a main line but mainly used as a sub line (or backup line) of a wired WAN line.

On the one hand, in an area in which it is practically difficult to lay the wired WAN line, such as a mountainous region, needs in which the wireless WAN line the cost of which is cheaper than that of the wired WAN line is used as the main line increases more than ever.

However, as described above, a communication quality of the wireless WAN line is lower than that of the wired WAN line. In order to secure sequentially of the communication, the sub line may be desired for the wireless WAN line that is a main line.

However, as such a sub line, a condition may be imposed that the communication quality is more excellent than that of the wireless WAN line that is the main line, and the price is cheap as compared with a conventional price. As one of lines that satisfies such a condition, for example, there is an ISDN (Integrated Services Digital Network). The ISDN is one of digital communication networks, and data (B channel or Bch) and a control signal (D channel or Dch) can be transmitted by a so-called “2B+D” system using a regular telephone line. The communication quality of the ISDN is, for example, more excellent than that of the wireless WAN line, however the fee of the used portion is charged by a pay-as-you-go system because the regular telephone line, etc. is used.

On the other hand, in a communication network system that includes the main line and the sub line, for example, a router apparatus, etc. is provided, and switching to the sub line can be performed by the router apparatus immediately after a line failure occurs in the main line. As a result, for example, sequentially or continuity of the communication can be secured. In addition, the router apparatus switches the line from the sub line to the main line when the main line is recovered from the line failure. As described above, the switching from the sub line to the main line may be referred to as switching back.

In a communication network system in which the wireless WAN line is used as the main line and the wired WAN line is used as the sub line, as a conventional technology that is related to such switching back, for example, there is the following technology. That is, there is a technology in which the switching back is performed so as to be delayed by a certain time (or protection time) in order to consider communication interruption and delay after the recovery in the main line even when switching back to the main line is performed. FIGS. 26A and 26B illustrates, for example, examples in communication states of the main line (FIG. 26A) and the sub line (FIG. 26B) when the switching back is performed so as to be delayed by such a certain time.

It is noted that, as a conventional technology that is related to a communication network system in which the wired WAN line is used as both of the main line and the sub line, there is the following technology. For example, in a multiplexing apparatus that includes an SD-I line of the main line and an INS line of the sub line, which has a narrower bandwidth than that of the SD-I line, the bandwidth of the SD-I line is narrowed down automatically when a failure of the SD-I line is detected, and the line is switched back to the SD-I line at the time of failure recovery.

In addition, there is a real time reception apparatus that measures a packet loss rate or jitter of a real time signal through an IP network to detect a sign of an increase in a transmission error, and performs switching to an ISDN line when the loss rate or jitter exceeds a threshold value and the state of the ISDN line is excellent.

Patent Document 1: Japanese Laid-open Patent Publication No. 2002-271338.

Patent Document 2: Japanese Laid-open Patent Publication No. 10-117176.

Patent Document 3: Japanese Laid-open Patent Publication No. 2004-112334.

Patent Document 4: Japanese Laid-open Patent Publication No. 2001-53794.

Patent Document 5: Japanese Laid-open Patent Publication No. 2006-340165.

However, in the communication network system in which the wireless WAN line is used as the main line, and the wired WAN line is used as the sub line, in a fee structure in which the sub line such as ISDN employs the pay-as-you-go system, when the router apparatus performs the switching back after the certain time elapses, a fee of a portion by which the connection to the ISDN is performed in a certain time is imposed.

For example, there is a case in which stable communication can be performed after the wireless WAN line that is the main line is recovered. In such a case, in the above-described technology in which the switching back is performed after the certain time elapses, the switching back to the main line is delayed by a certain time portion although the main line is stable, so that wasted charging occurs because the connection to the ISDN is performed in the certain time.

On the other hand, there is a case in which the wireless WAN line that is the main line does not become stable even after the certain time elapses, and the line failure occurs soon again. In such a case, even when the router apparatus performs the switching back after the certain time elapses, the communication may be disconnected due to the line failure of the main line. Thus, in such a case, continuity of the communication cannot be secured. In addition, there is a case in which delay such as switching time that is associated with switching of the line occurs when the main line is switched to the sub line again after the switching back, so that the continuity of the communication may also not be able to be secured.

In addition, in the technology in which the bandwidth of the SD-I line is narrowed down automatically when the failure of the SD-I line is detected, data that is transferred to the SD-1 line is not transmitted to a transmission destination because a failure of the SD-I line occurs even when the bandwidth of the SD-I line is narrowed down, so that there is a case that the continuity of the communication not be secured.

In addition, in the technology that is related to switching from the IP network to the ISDN network, charging occurs due to the switching to the ISDN network, and wasted charging may occur as described above when the switching back to the IP network is not performed at appropriate timing.

### SUMMARY

According to an aspect of the embodiments, a router apparatus for performing communication by switching a first and second line, the router apparatus includes: a setting unit which sets a first protection time until the first line is switched to the second line after a line failure in the first line is detected, and a second protection time until the second line is switched to the first line after recovery from the line failure in the first line is detected, to times corresponding to a quality state of the first line, respectively; and a line switching unit which switches the first line to the second line when the first protection time elapses and the line failure in the first line continues, or switches the second line to the first line when the second protection time elapses after the line failure in the first line is detected.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is diagram illustrating a configuration example of a communication network system.

FIG. 2 is diagram illustrating a configuration example of a communication network system.

FIGS. 3A and 3B are diagrams illustrating operation examples of line switching.

FIGS. 4A and 4B are diagrams illustrating operation examples of line switching.

FIGS. 5A and 5B are diagrams illustrating operation examples of line switching.

FIGS. 6A and 6B are diagrams illustrating operation examples of line switching back.

FIGS. 7A and 7B are diagrams illustrating operation examples of line switching back.

FIG. 8 is a graph illustrating a relationship example between jitter and a communication speed.

FIG. 9 is diagram illustrating an example of a measurement method of a quality state of a wireless WAN line.

FIG. 10 is diagram illustrating an example of quality determination in the wireless WAN line.

FIG. 11 is a diagram illustrating a configuration example in a router apparatus.

FIG. 12 is a flowchart illustrating an operation example of transmission processing of an ICMP message.

FIG. 13 is a flowchart illustrating an operation example of reception processing of an ICMP message.

FIG. 14 is a diagram illustrating an example of a threshold value management table.

FIG. 15 is a flowchart illustrating an operation example of quality determination processing in the wireless WAN line.

FIG. 16 is a diagram illustrating an example of a wireless WAN quality state table 106.

FIG. 17 is a flowchart illustrating an operation example of setting processing of a switching protection time and a switching back protection time.

FIG. 18A is a diagram illustrating an example of a line state table, FIG. 18B is a diagram illustrating an example of a timer table, and FIG. 18C is a diagram illustrating an example of a protection time table.

FIG. 19 is a flowchart illustrating an operation example of protection time count processing.

FIGS. 20A and 20B are diagrams illustrating examples of a routing table.

FIG. 21 is a flowchart illustrating an operation example of protection time count processing.

FIG. 22 is a flowchart illustrating an operation example of processing of determining whether a wired line in the routing table is valid or invalid.

FIG. 23 is a flowchart illustrating an operation example of registration processing to the protection time table.

FIG. 24 is a diagram illustrating a configuration example of a communication network.

FIG. 25 is a diagram illustrating a configuration example of the router apparatus.

FIGS. 26A and 26B are diagrams illustrating operation examples of switching processing and switching back processing.

### DESCRIPTION OF EMBODIMENTS

The embodiments are described in detail below with reference to the drawings.

### First Embodiment

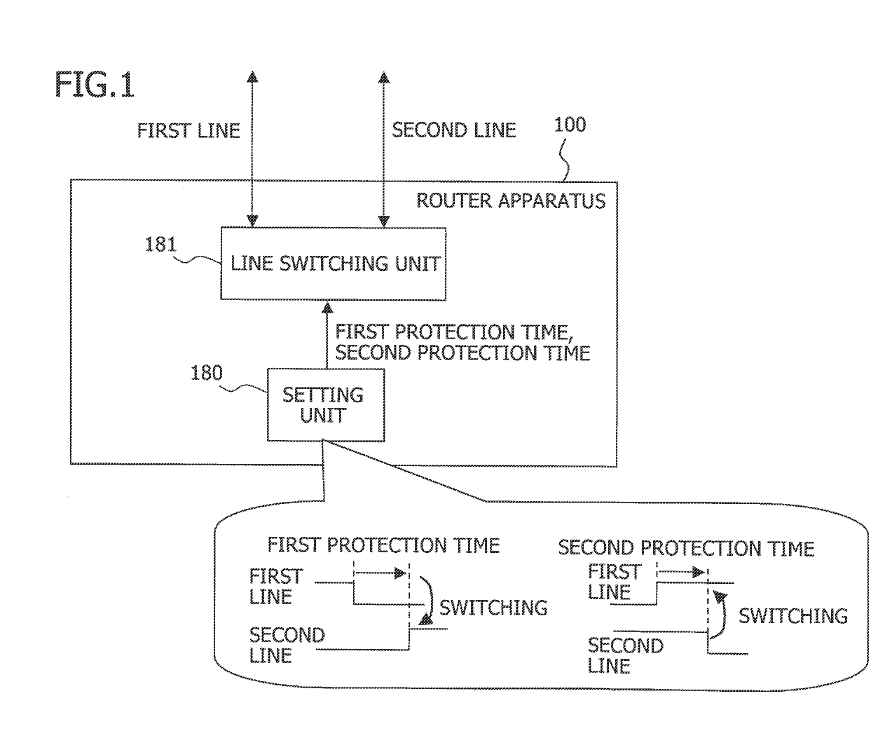

FIG. 1 is a configuration example of a router apparatus 100 in a first embodiment. The router apparatus 100 can perform communication by switching a first line and a second line. The router apparatus 100 includes a setting unit 180 and a line switching unit 181.

The setting unit 180 can set a first protection time until the first line is switched to the second line after a line failure in the first line is detected, to a time corresponding to a quality state of the first line. In addition, the setting unit 180 can set a second protection time until the second line is switched to the first line after recover from the line failure in the first line is detected, to the time corresponding to the quality state of the first line.

The line switching unit 181 performs switching the first line to the second line when the first protection time elapses and the line failure in the first line continues. Alternatively, the line switching unit 181 can perform switching the second line to the first line when the second protection time elapses after the line failure in the first line is detected.

As described above, the router apparatus 100 sets the first protection time and the second protection time at times that are not fixed and correspond to the quality state of the first line. In addition, the router apparatus 100 performs the switching from first line to the second line or the switching (or switching back) from second line to the first line in accordance with the set first and second protection times.

Therefore, for example, the first protection time and the second protection time are times for which the quality state of the first line is consider as compared with the fixed time, so that the router apparatus can perform the constant communication even when the switching or the switching back of the line is performed.

In addition, for example, switching back is performed in accordance with the first line state even when the second line employs the pay-as-you-go system, and wasted charging can be avoided because the second protection time that corresponds to the quality state of the first line is set as compared with a case in which the second protection time is fixed.

### Second Embodiment

<Whole System Example>

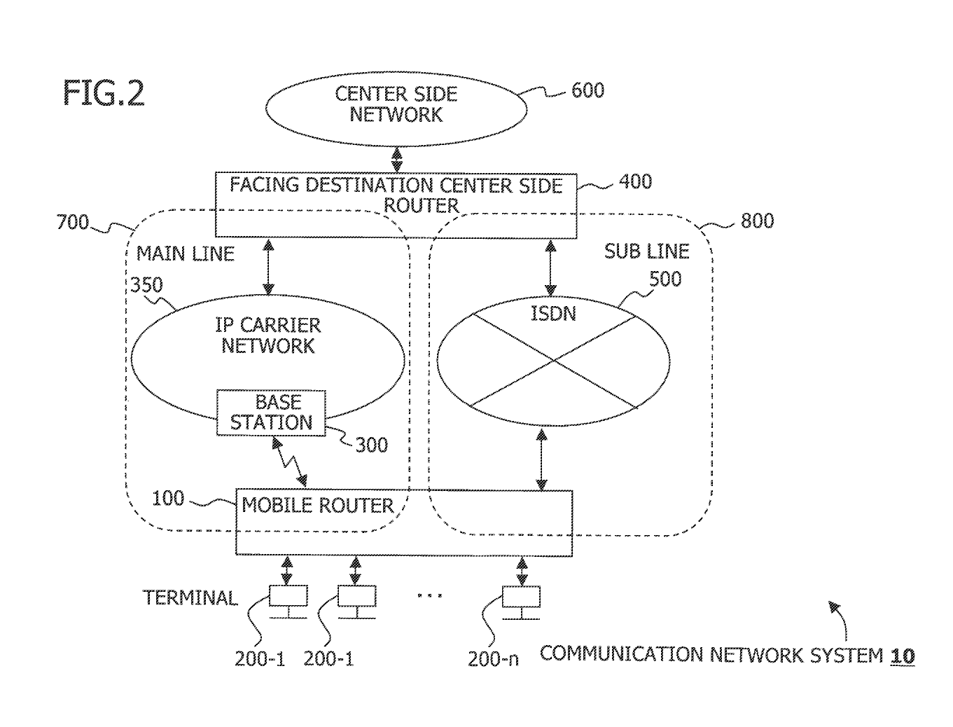

FIG. 2 is diagram illustrating a configuration example of a communication network system 10 according to a second embodiment. The communication network system 10 includes a mobile router apparatus (hereinafter referred to as “router apparatus”) 100, terminals 200-1 to 200-n, a base station 300, an IP carrier network 350, a facing destination center side router apparatus (hereinafter referred to as “center side router apparatus”) 400, an ISDN network 500, and a center side network 600.

The communication network system 10 is, for example, an ATM (Automatic teller machine) network system, etc. of a post office, and deposit, etc. of cash can be automatically performed by performing access to the facing destination center side router 400 from the terminals 200-1 to 200-n. Alternatively, the communication network system 10 can also operate, for example, as a so-called client server system by using the terminals 200-1 to 200-n as a client and using the center side router apparatus 400 as a server, etc.

As illustrated in FIG. 2, in the communication network system 10, the router apparatus 100 is connected to the base station 300 through a wireless line, and the router apparatus 100 and the base station 300 can perform radio communication with each other. In the communication network system 10, configuration elements other than the router apparatus 100 and the base station 300 are connected to each other through a wired line.

In the communication network system 10, a line between the router apparatus 100 and the center side router apparatus 400, which includes such a wireless line is a main line 700, and a line that includes the ISDN network 500 is a sub line 800. In the embodiment, as appropriate, the main line is referred to as the wireless WAN line, and the sub line is referred to as the wired WAN line. In addition, the line between the router apparatus 100 and the base station 300 may be referred to as the wireless WAN line, and the ISDN network may be referred to as the wired WAN line.

The router apparatus 100 can receive data and a signal that are transmitted from the terminals 200-1 to 200-n and transmit the data and the signal to the main line or the sub line, as appropriate. In addition, the router apparatus 100 can also transmit data and a signal that are received through the main line or sub line, to the terminals 200-1 to 200-n, as appropriate. The router apparatus 100 can also perform radio communication with the base station 300. The detail of the router apparatus 100 is described later.

The terminals 200-1 to 200-n are connected to the router apparatus 100 through a LAN (Local Area Network), etc., data and a signal to be transmitted to the center side router apparatus 400 can be transmitted to the router apparatus 100. In addition, the terminals 200-1 to 200-n can receive data and a signal that are transmitted from the center side router apparatus 400, through the router apparatus 100. It is noted that, in the example of FIG. 2, the example of the plurality of terminals 200-1 to 200-n is illustrated, however, for example, the terminals 200-1 to 200-n may be illustrated as one terminal. The terminals 200-1 to 200-n can be installed, for example, in a window of the post office.

The base station 300 is also a radio communication apparatus that performs radio communication with the router apparatus 100, and is connected to the IP carrier network 350. The base station 300 can convert a radio signal that is received from the router apparatus 100 into data and a signal that are transmitted from the terminals 200-1 to 200-n (perform down-conversion) and output the converted data and signal to the center side router apparatus 400 in order to perform the radio communication through the wireless line. In addition, the base station 300 can convert data and a signal that are received from the center side router apparatus 400 into a radio signal (perform up-conversion) and transmit the converted radio signal to the router apparatus 100. It is noted that, in the example of FIG. 2, the base station 300 is illustrated as a single station, however, a plurality of stations may be employed. The base station 300 is connected to the IP carrier network 350, for example, through a host apparatus, etc. for the base station 300, however, for ease of explanation, in FIG. 2, the base station 300 is connected to the IP carrier network. The base station 300 may be, for example, a radio LAN access point.

The IP carrier network 350 is, for example, a wide area IP (Internet Protocol) communication network that is possessed by a carrier, and can connect networks at remote locations each other. Such an IP carrier network 350 may be referred to, for example, as an IP-VPN (IP-Virtual Private Network). The IP carrier network 350 is connected to the center side router apparatus 400 through a wired line.

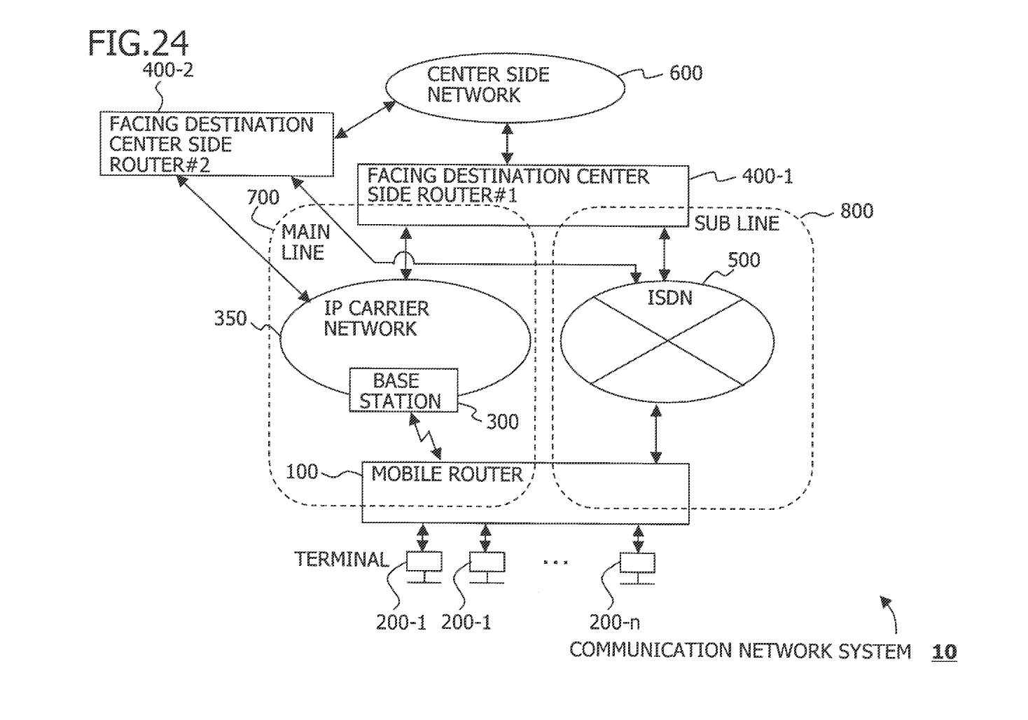

The center side router apparatus 400 is an access destination of the terminals 200-1 to 200-n, can store the data and signal that are transmitted from the terminals 200-1 to 200-n in an internal memory, and can read the corresponding data from the memory and transmit the data to the terminals 200-1 and 200-2. It is noted that, in the example of FIG. 2, the center side router apparatus 400 is illustrated as a single apparatus, however the plurality of center side router apparatuses 400 that are connected to the center side network 600 may be employed (for example, FIG. 24 that is described later).

The ISDN line 500 is, for example, a digital communication network in which a telephone, a facsimile, data communication, etc. are integrated and used, and standardized by International Telecommunication Union Telecommunication Standardization sector (ITU-TS). The ISDN line 500 can perform communication, for example, using a BRI (Basic Rate Interface), etc. by a B channel (or Bch) of 64 kbps for data and a D channel (or Dch) of 16 kbps for a control signal. It is noted that, in the embodiment, for example, a wired line other than the ISDN line 500 may be employed as long as a wired line of the pay-as-you-go system in which charging is performed depending on a communication time, a communication amount, etc. is employed.

The center side network 600 is, for example, a network that is connected to the center side router apparatus 400. To the center side network 600, the plurality of center side router apparatuses 400 may be connected.

<Switching Operation at the Time of Line Failure Occurrence>

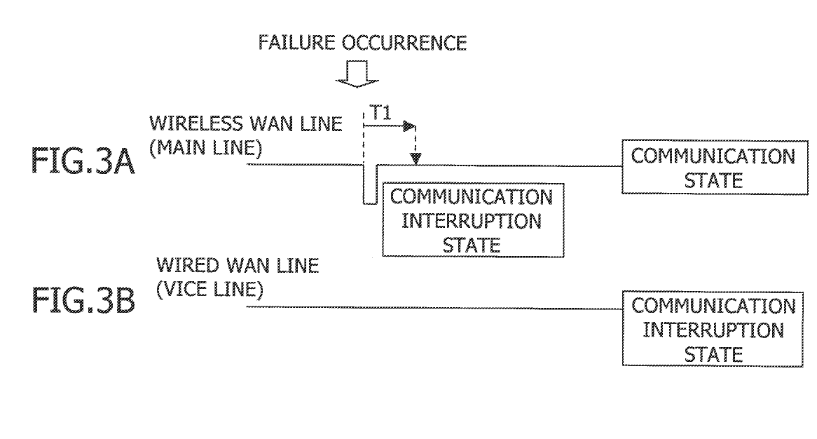

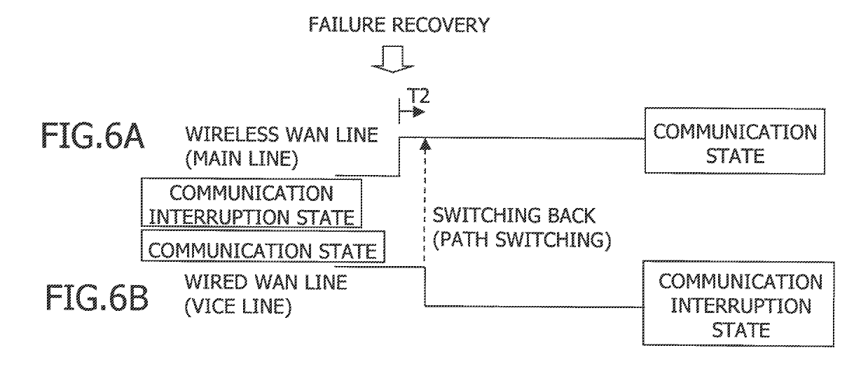

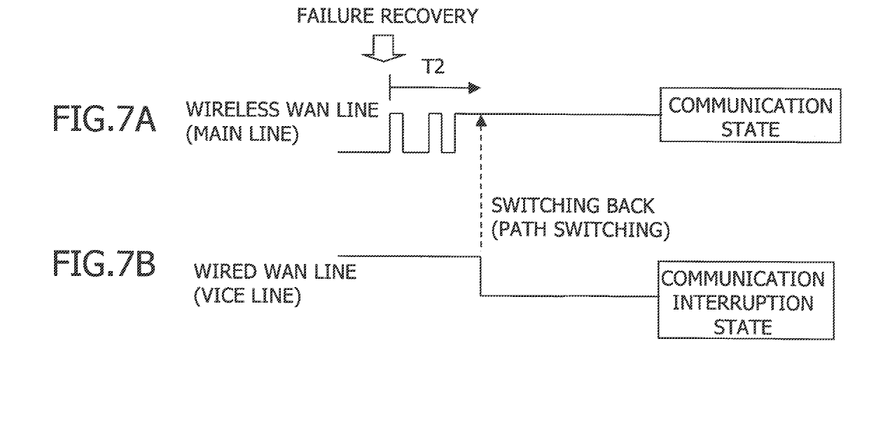

A switching operation at the time of occurrence of a line failure in the router apparatus 100 is described below. FIGS. 3A to 5B illustrate operation examples when a line failure occurs in the main line, and FIGS. 6A to 7B illustrate operation examples when recovery from the line failure in the main line occurs. It is noted that, switching that is performed from the main line to the sub line after the line failure occurs in the main line is referred to as “switching”, and switching that is performed from the sub line to the main line when recovery from the line failure in the main line occurs after the switching is referred to as “switching back”, as appropriate.

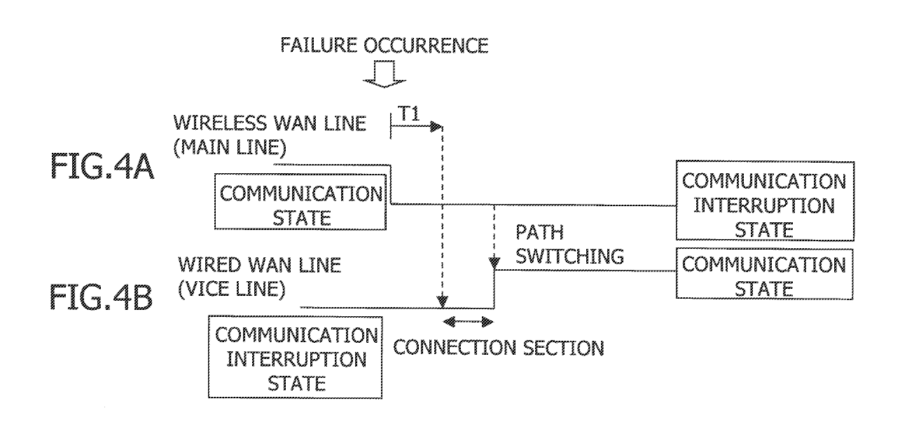

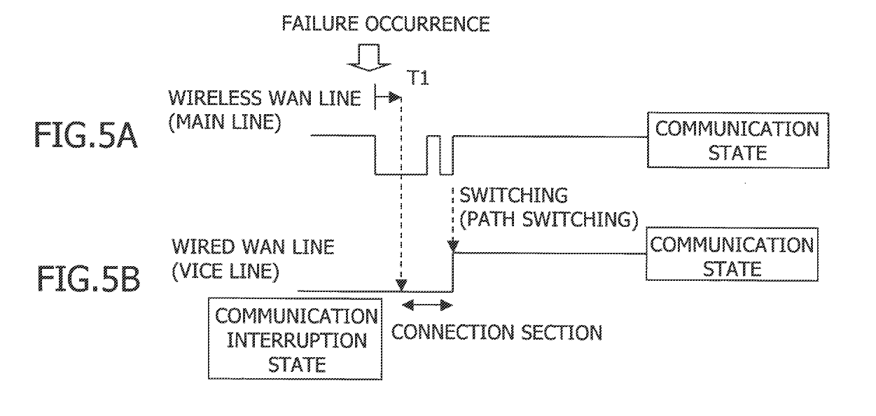

FIGS. 3A to 4B illustrate examples of switching operations when a line failure such as disconnection or delay of the communication occurs in a state in which the wireless WAN line that is the main line is stable. In addition, FIGS. 5A and 5B illustrate examples of switching operations when the line failure such as disconnection or delay of the communication occurs in a state in which the wireless WAN line that is the main line is unstable. As described above, the state of the line failure is, for example, a state in which a failure such as disconnection or delay of the communication occurs and the communication cannot be performed.

The state in which the wireless WAN line is stable (or stable state) is, for example, a state in which a probability that a line failure occurs is lower than a first threshold value and radio communication of data and a signal is performed stably. On the one hand, the state in which the wireless WAN line is unstable (or unstable state) is, for example, a state in which a probability that a line failure occurs is higher than the first threshold value, and the radio communication of data and a signal is not performed stably. A communication amount of the stable state (or first state) is larger than that of the unstable state (or second state), and a communication speed of the stable state is faster than that of the unstable state, and in the stable state, the radio communication can be performed without delay.

As illustrated in FIGS. 3A and 3B, for example, when a line failure occurs in the wireless WAN line that is the main line, the state becomes a state in which the communication cannot be performed (hereinafter referred to as “communication interruption state”, as appropriate). In such a case, even when the line failure occurs in the main line, the failure temporarily occurs, and it is also probable that the state returns to the original state in which the communication can be performed (hereinafter referred to as “communication state” as appropriate). Therefore, the router apparatus 100 sets a switching protection time T1 that is used for switching to the sub line and waits for the switching to the sub line until the switching protection time T1 elapses. In the examples of FIGS. 3A and 3B, a state is illustrated, in which recovery from the line failure occurs, reconnection to the wireless WAN line is performed, and switching to the sub line that is the wired WAN line does not occur in the switching protection time T1.

As described above, by setting the switching protection time T1 for switching, communication delay that is associated with the switching to the sub line can be avoided. That is, until switching to sub line is actually performed, processing for the connection is executed in the wired WAN line that is the sub line, and the switching to the sub line is performed after the processing is waited. As described above, the communication delay occurs due to the processing time for switching, however the processing time for switching is removed due to the switching protection time T1, and the communication delay can be avoided. In addition, when communication of broadband can be performed in the wireless WAN line that is the main line as compared with the wired WAN line that is the sub line, the communication of broadband can be performed continuously, so that continuous service can be also provided.

In addition, for example, as illustrated in FIGS. 4A and 4B, when the line failure in the wireless WAN line continues even after the switching protection time T1 elapses, the router apparatus 100 performs the switching to the sub line. For example, the router apparatus 100 instructs the switching to the sub line, and performs connection processing to the sub line after the switching protection time T1 elapses, and can actually perform the switching to the sub line by the path switching instruction.

Similarly, FIGS. 5A and 5B illustrate examples of switching operations when a line failure occurs in the main line, and also illustrate examples of switching operations when the main line is in the unstable state. In the case of such examples, when the line failure continues in the wireless WAN line after the switching protection time T1 elapses, the switching to the sub line is performed.

In the embodiment, the switching protection time T1 in which the wireless WAN line that is the main line is in the unstable state is shorter than the switching protection time T1 in which the wireless WAN line that is the main line is in the stable state.

Therefore, the communication state and the communication interruption state are repeated in the wireless WAN line when the main line is the unstable state. In such a state, in a case in which a line failure in the main line is detected, the continuous communication can be obtained when the switching to the wired line is performed in which stable communication can be performed as compared with the main line that is in the unstable state. In a case in which the main line is in the unstable state, when the switching to the sub line or the switching back is performed each time the communication interruption state and the communication state are repeated, the communication delay that is associated with the switching occurs. In order to avoid such delay due to the switching and perform the continuous communication, in the embodiment, the switching protection time T1 in which the main line is in the unstable state is shorter than the switching protection time T1 in which the main line is in the stable state.

On the one hand, it can be conceived that the switching protection time T1 in the stable state is longer than a switching protection time T2 in the unstable state. Therefore, in the case in which the wireless WAN line that is the main line is in the stable state, even when a line failure occurs in the main line, it is probable that recovery from the line failure is performed immediately (for example, FIG. 3A). When the recovery from the line failure in the wireless WAN line that is in the stable state is considered as compared with the communication delay that is associated with the switching, the switching protection time T1 in the stable state is longer than the switching protection time T1 in the unstable state.

In addition, FIGS. 6A to 7B illustrate diagrams of operation examples in the case of “switching back”. This is a case in which the line is switched from the main line to the sub line by “switching”, and then “switching back” from the sub line to the main line is performed after recovery from the line failure in the main line occurs. FIGS. 6A and 6B, out of FIGS. 6A to 7B, illustrate operation examples of the switching back in which the main line is in the stable state.

In the embodiment, when recovery form the line failure in the main line occurs, the router apparatus 100 waits until a switching back protection time T2 for the switching back elapses, and performs the switching back to the main line after the switching back protection time T2 elapses. The switching back protection time T2 is sets by considering the communication delay, etc. due to the switching operation in such a case because, for example, it is probable that a line failure occurs again immediately after the line recovery even when recovery from the line failure in the main line occurs.

However, in the embodiment, the switching back protection time T2 in which the main line is in the stable state is shorter than the switching back protection time T2 in which the main line is in the unstable state.

Therefore, when recovery from the line failure occurs in a case in which the main line is in the stable state, a probability that the main line becomes stable as is and the radio communication can be perform is higher than that of the unstable state, and for example, communication can be performed, in which the communication speed is high and that corresponds to broadband using the wireless WAN line, as compared with the sub line by performing the switching back to the main line as soon as possible. In addition, when the sub line is a communication line, such as the ISDN line, of the pay-as-you-go system in which charging is performed depending on a connection time or a communication amount, the connection time of the sub line is reduced as the protection time for switching back is reduced, so that the wasted charging can be avoided.

On the other hand, as illustrated in FIGS. 7A and 7B, in the case in which the main line is in the unstable state, when switching back to the main line is performed similar to the case in which the main line is in the stable state, it is probable that a line failure is detected again and the switching to the sub line is performed. When the switching or the switching back is performed each time such a state is repeated, the communication delay that is associated to the switching, etc. occurs, and continuous communication cannot be performed. Thus, the switching back protection time T2 in which the main line is in the unstable state is longer than the switching back protection time T2 in which the main line is in the stable state.

As described above, the router apparatus 100 holds two protection times of the switching protection time T1 and the switching back protection time T2, and changes the respective lengths of the two protection times T1 and T2 depending on a quality state (or line state) of the wireless WAN line that is the main line.

In order to execute such processing, it is desirable that the router apparatus 100 obtains a quality state of the wireless WAN line that is the main line at least at the time of occurrence of a line failure or at the time of occurrence of recovery from the line failure, and grasps whether the main line is in the stable state or the unstable state, on the basis of the obtained result. The obtaining processing of a quality state of the wireless WAN line is described below.

<Obtaining Processing of a Quality State of the Wireless WAN Line>

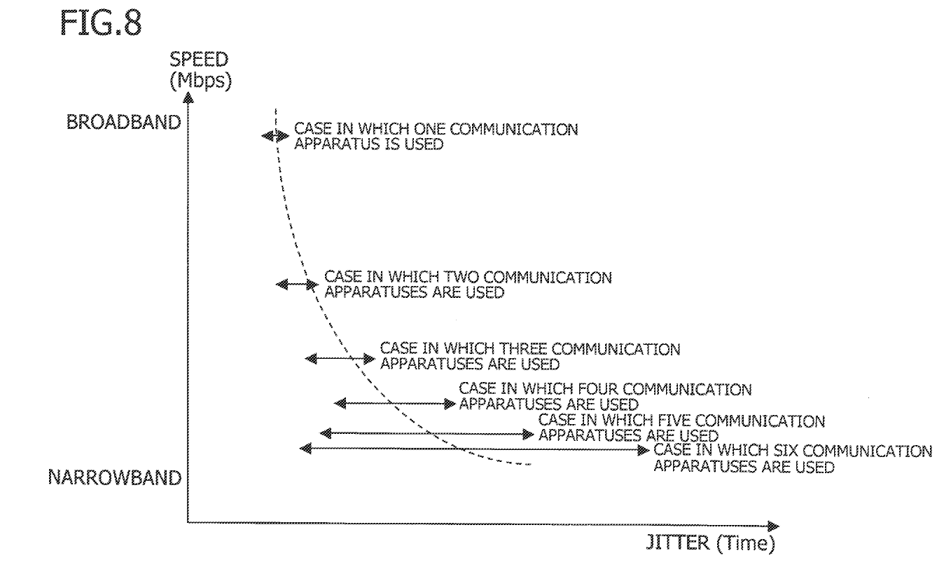

FIGS. 8 to 10 are diagrams illustrating obtaining processing of a quality state. FIG. 8 is a graph illustrating that a bandwidth or a speed is reduced and variation of jitter increases when the number of communication apparatuses increases. The vertical axis indicates a communication speed, and the horizontal axis indicates jitter (or a delay time). The jitter is, for example, a delay time or fluctuation of a round-trip time until corresponding reply is received after data and a signal are transmitted to a transmission destination.

For example, in the wireless line, etc., a bandwidth in which the communication can be performed, an amount of communication that can be performed, etc. are set beforehand. In such a finite radio resource, as the number of used communication apparatuses is reduced, a radio resource that is allocated to each of the communication apparatuses increases, so that the communication speed becomes high, and variation (or width) of the jitter is also reduced. On the other hand, as the number of communication apparatuses that use the wireless line increases, a radio resource that is allocated to each of the communication apparatuses is reduced on the contrary, so that the communication speed of each of the communication apparatuses is reduced as compared with the case in which the only one communication apparatus is used. In addition, the width variation of jitter of the communication apparatuses becomes large as compared with variation of jitter when the only one communication apparatus is used.

For example, the router apparatus 100 constantly monitors change in jitter, and the wireless WAN line can be set in the unstable state when the jitter increases and can also be set in the stable state when the jitter is reduced on the contrary. The router apparatus 100 can manage the quality state of the wireless WAN depending on the change in jitter.

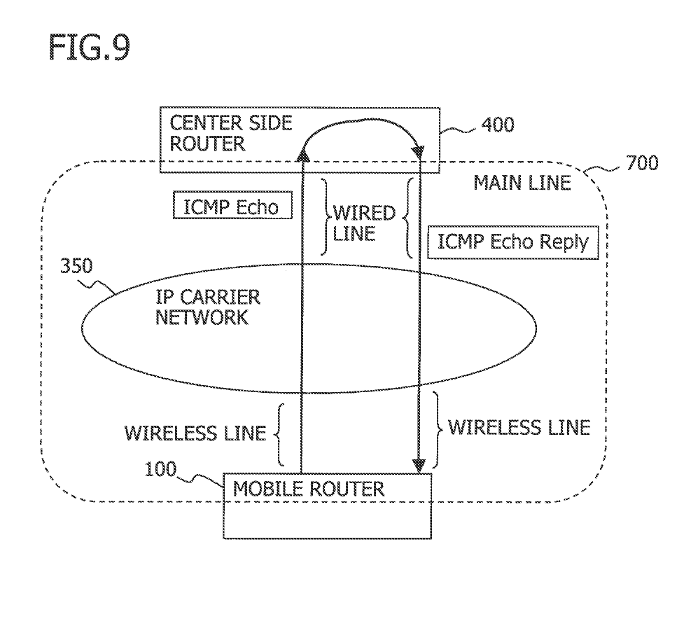

FIG. 9 is a diagram illustrating an example of a measurement method of a quality state of the wireless WAN line. As a specific example of the measurement of a quality state, for example, an ICMP (Internet Control Message Protocol) message can be used. For example, the router apparatus 100 transmits an Echo message (echo request notification) of the ICMP message. The center side router apparatus 400 that is the destination replies an ICMP Echo Reply (echo response notification) message by switching the transmission source and the transmission destination. For example, the router apparatus 100 can measure a time of the round-trip by transmitting the ICMP Echo message into which a transmission time is inserted and comparing the transmission time and a reception time at which the ICMP Echo Reply message is received.

As described above, for example, after the router apparatus 100 transmits a message to the transmission destination (center side router apparatus 400, etc.), the router apparatus 100 can measure, for example, fluctuation of the round-trip time until the router apparatus 100 receives a reply message for the message, as jitter. In this case, for example, the router apparatus 100 can determine the state of the wireless WAN line as the unstable state when the round-trip time increases and also determine the state of the wireless WAN line as the stable state when the round-trip time is not changed or is reduced.

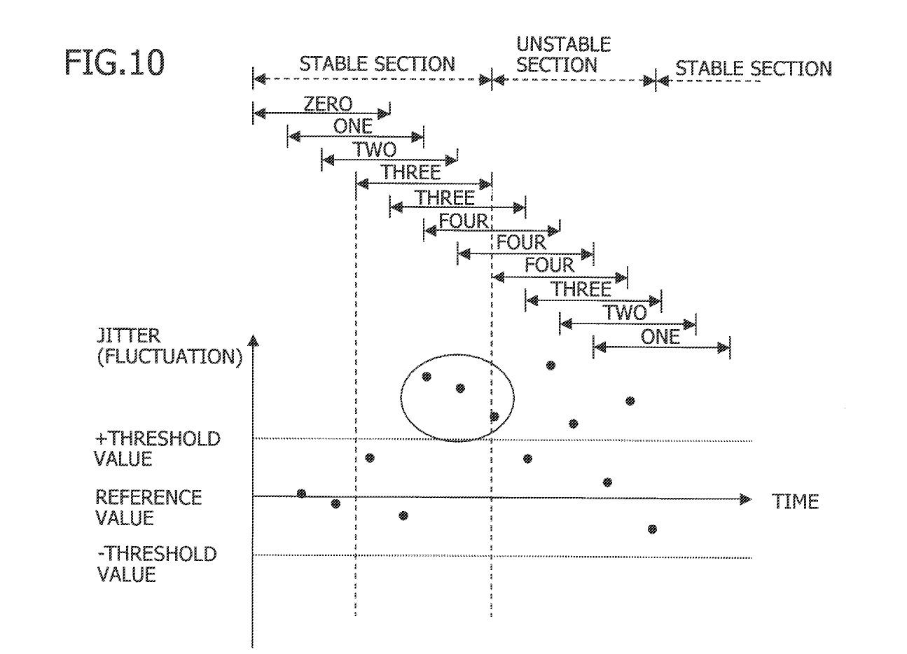

FIG. 10 is a diagram illustrating determination of a quality state of the wireless WAN line. The router apparatus 100 can measure variation of jitter by calculating a difference between the measured round-trip time and a reference value. In addition, the router apparatus 100 calculates the number of times in which the round-trip times exceeds a second threshold value in a certain time width, and can determine the state of the wireless WAN line as the unstable state when the number of times is a fixed value or more and determine the state of the wireless WAN line as the stable state when the number of times is less than the fixed value. In the example of FIG. 10, the router apparatus 100 determines the state of the wireless WAN line as the unstable state when the number of times in which the round-trip time width exceeds the second threshold value in the certain time is three or more, and the router apparatus 100 determines the wireless WAN line as the stable state when the number of times in which the round-trip time width exceeds the second threshold value in the certain time is less than three. As described above, the router apparatus 100 does not determine the quality state of the main line by the only one measurement of the round-trip time but can determine the quality state of the main line on the basis of a statistical calculation result in a certain time. Therefore, the router apparatus 100 can constantly monitor the quality state of the wireless WAN line by transmitting a message to the center side router apparatus 400 periodically (for example, every one second).

<Configuration Example of the Router Apparatus 100>

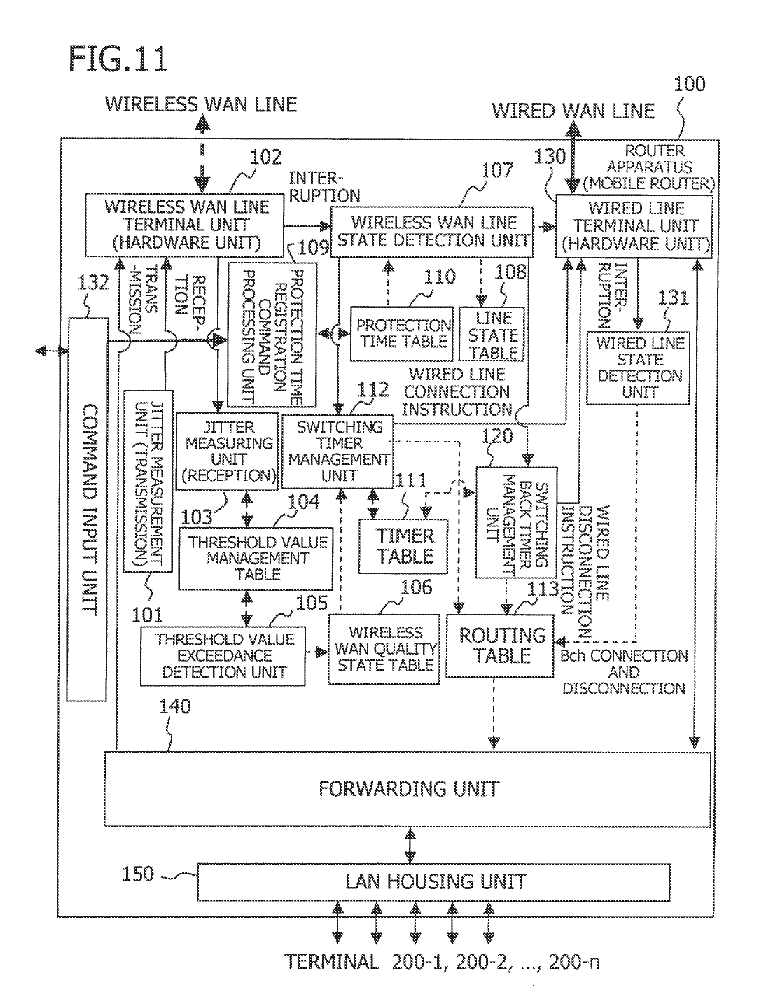

A configuration example of the router apparatus 100 is described below. FIG. 11 is a diagram illustrating the configuration example of the router apparatus 100.

The router apparatus 100 includes a jitter transmission side measurement unit 101, a wireless WAN line termination unit 102, a jitter reception side measurement unit 103, a threshold value management table 104, a threshold value exceedance detection unit 105, a wireless WAN quality state table 106, a wireless WAN line state detection unit 107, a line state table 108, a protection time registration command processing unit 109, a protection time table 110, a timer table 111, a switching timer management unit 112, a routing table 113, a switching back timer management unit 120, a wired line termination unit 130, a wired line state detection unit 131, a command input unit 132, a forwarding unit 140, and a LAN housing unit 150.

In the router apparatus 100, the jitter transmission side measurement unit 101, the threshold value exceedance detection unit 105, the switching timer management unit 112, and the switching back timer management unit 120 can operate, for example, periodically. The whole processing amount of the router apparatus 100 and an electric power amount that is used to operate the router apparatus 100 can be reduced as compared with a case in which the router apparatus 100 keeps operating. It is noted that, the jitter transmission side measurement unit 101, the threshold value exceedance detection unit 105, the switching timer management unit 112, and the switching back timer management unit 120 can also keep operating instead of the periodical operation.

It is noted that, the detail of each of the units is described in order in the following operation examples with reference to the operation examples.

In addition, the setting unit 180 according to the first embodiment corresponds to, for example, the jitter transmission side measurement unit 101, the wireless WAN line termination unit 102, jitter reception side measurement unit 103, the threshold value management table 104, the threshold value exceedance detection unit 105, the wireless WAN quality state table 106, the wireless WAN line state detection unit 107, the line state table 108, the protection time registration command processing unit 109, the protection time table 110, the timer table 111, and the command input unit 132. In addition, the line switching unit 181 according to the first embodiment corresponds to, for example, the switching timer management unit 112, the routing table 113, the switching back timer management unit 120, and the forwarding unit 140.

<Operation Example>

An operation example in the router apparatus 100 is described below. The router apparatus 100 measures and determines a quality state of the wireless WAN line, for example, and sets the switching protection time T1 and the switching back protection time T2 depending on the determined quality state. In addition, the router apparatus 100 executes the switching processing, the switching back processing, etc. on the basis of the two protection times T1 and T2.

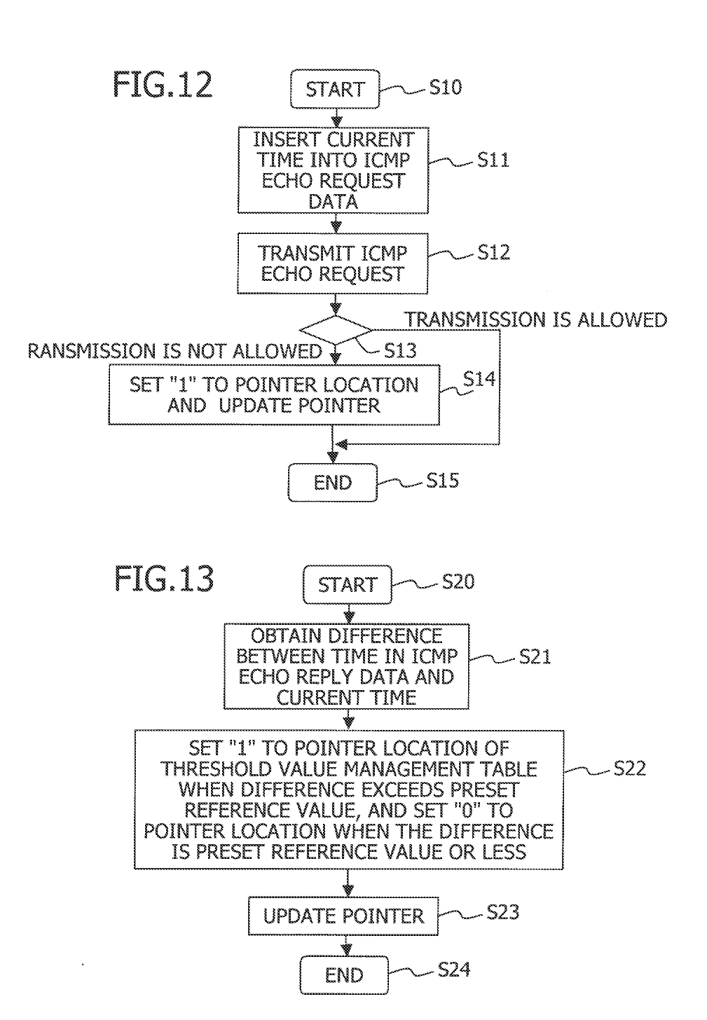

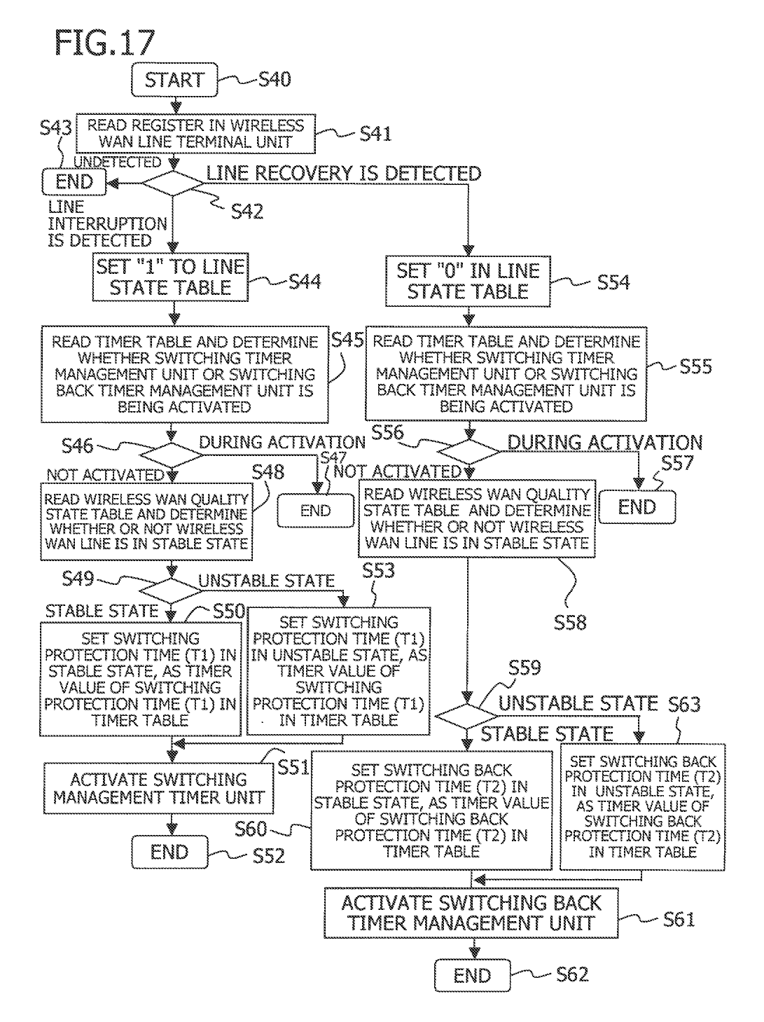

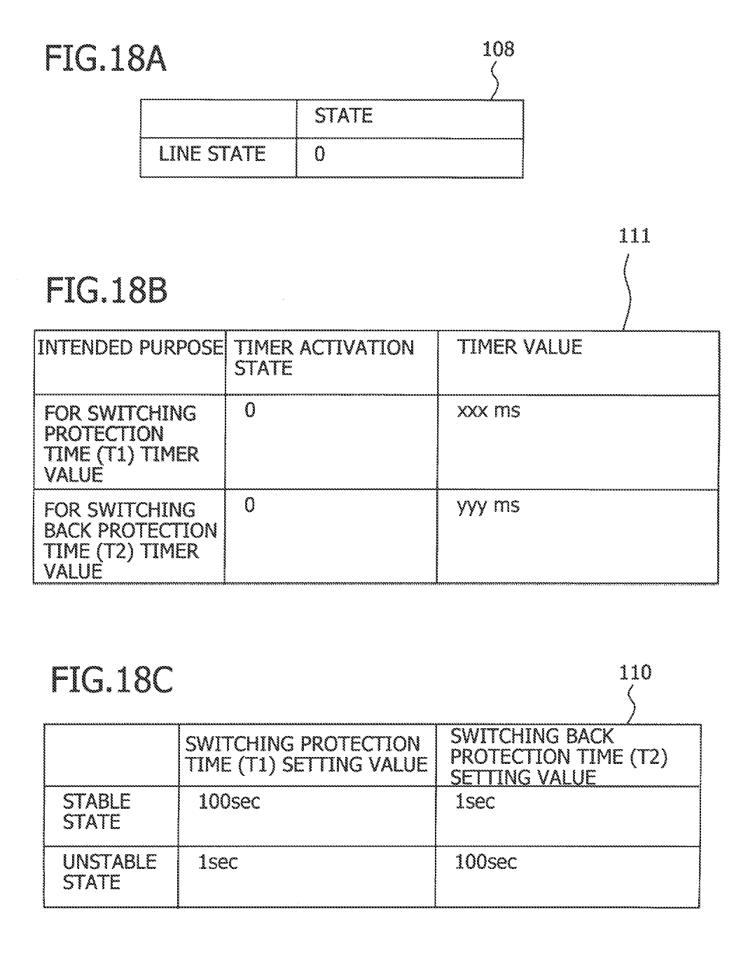

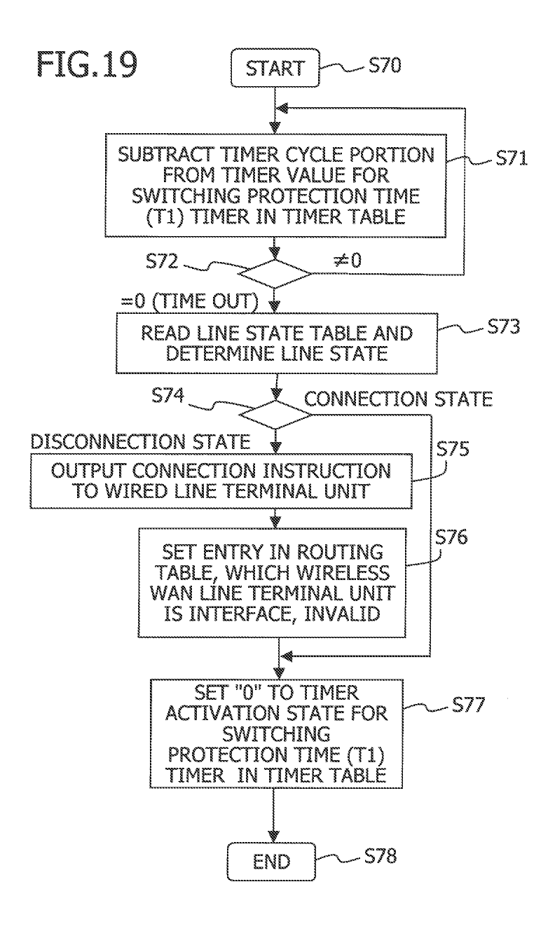

Thus, in the operation example, for ease of understanding, first, processing of measuring and determining a quality state of the wireless WAN line that is the main line is described (for example, FIGS. 12 to 16). Next, setting processing of the switching protection time T1 and the switching back protection time T2 depending on the quality state is described (for example, FIGS. 17 to 18C). At last, switching processing, switching back processing, etc. based on the set protection times T1 and T2 (FIGS. 19 to 23) are described. It is noted that, order of the pieces of processing can be also changed as appropriate.

<1. Measurement Processing and Determination Processing of a Quality State of the Wireless WAN Line>

First, the measurement processing of a quality state of the wireless WAN line that is the main line and the determination processing of the quality state of the wireless WAN line are described with reference to FIGS. 12 and 16. FIG. 12, out of FIGS. 12 and 16, is a flowchart illustrating an example of transmission processing of an ICMP Echo Request message in the measurement processing using an ICMP message. The processing is executed, for example, by the jitter transmission side measurement unit 101.

The jitter transmission side measurement unit 101 starts the processing, for example, periodically (for every one second, etc.) (S10). In addition, the jitter transmission side measurement unit 101 inserts a current time into an ICMP Echo Request message (S11).

After that, the jitter transmission side measurement unit 101 transmits an ICMP Echo Request into which the current time is inserted, to the center side router apparatus 400 through the wireless WAN line termination unit 102 (S12). For example, the wireless WAN line termination unit 102 can execute processing, etc. of converting the ICMP Echo Request message into a radio signal, etc., and can transmit the ICMP Echo Request message to the base station 300 as the radio signal.

However, a line failure occurs in the wireless WAN line, so that the ICMP Echo Request message may not be transmitted to the wireless WAN line. Therefore, the jitter transmission side measurement unit 101 determines whether or not the ICMP Echo Request message is transmitted (S13). For example, the wireless WAN line termination unit 102 constantly monitors whether or not the wireless WAN line is in a state in which the communication can be performed, and outputs notification that indicates whether or not the ICMP Echo Request message is transmitted, to the jitter transmission side measurement unit 101. For example, the jitter transmission side measurement unit 101 can determine whether or not the ICMP Echo Request message is transmitted, on the basis of notification.

The jitter transmission side measurement unit 101 terminates the processing (S15) when the ICMP Echo Request message is transmitted (“transmission is allowed” in S13). In addition, the jitter transmission side measurement unit 101 executes processing of updating a pointer (S14) when the ICMP Echo Request message does not transmitted (“transmission is not allowed” in S13).

The router apparatus 100 determines a quality state of the wireless WAN line not by one time of measurement but by statistics results that are obtained by a plurality of times of measurement, and assigns an index to each of the results that are obtained by the measurement. In addition, the router apparatus 100 sequentially performs a series of pieces of measurement from the initial measurement periodically, and performs the series of pieces of measurements from the initial measurement again when the series of pieces of measurement stops in the middle. Therefore, the jitter transmission side measurement unit 101 executes the processing of updating a pointer again as processing of assigning the indexes from the initial value again when the ICMP Echo Request message cannot be transmitted. The index value can be also included, for example, in the ICMP Echo Request message by the jitter transmission side measurement unit 101. The jitter transmission side measurement unit 101 terminates the processing after the pointer is updated (S15).

FIG. 13 is a flowchart illustrating an example of jitter measurement processing in the jitter reception side measurement unit 103. It is assumed that the message is transmitted in the transmission processing of the ICMP Echo Request message by the jitter transmission side measurement unit 101, and an ICMP Echo Reply message for the message is replied to the router apparatus 100 from the center side router apparatus 400. In addition, it is assumed that, into the ICMP Echo Reply message, the current time (or transmission time in S11) that is inserted into the ICMP Echo Request message is inserted.

When the jitter reception side measurement unit 103 starts the processing (S20), the jitter reception side measurement unit 103 accepts an input of an ICMP Echo Reply message from the wireless WAN line termination unit 102, and obtains a difference (or round-trip time) between a transmission time that is included in the message and a current time in which the message is received (S21).

After that, the jitter reception side measurement unit 103 sets “1” to a position that is indicated by the pointer of the threshold value management table 104 when the difference exceeds the second threshold value, and sets “0” to the position when the difference is the second threshold value or less (S22). The second threshold value is, for example, “threshold value” in FIG. 10, and the determination can be performed on the basis of whether a round-trip time for a reference value (for example, 300 ms) exceeds the second threshold value.

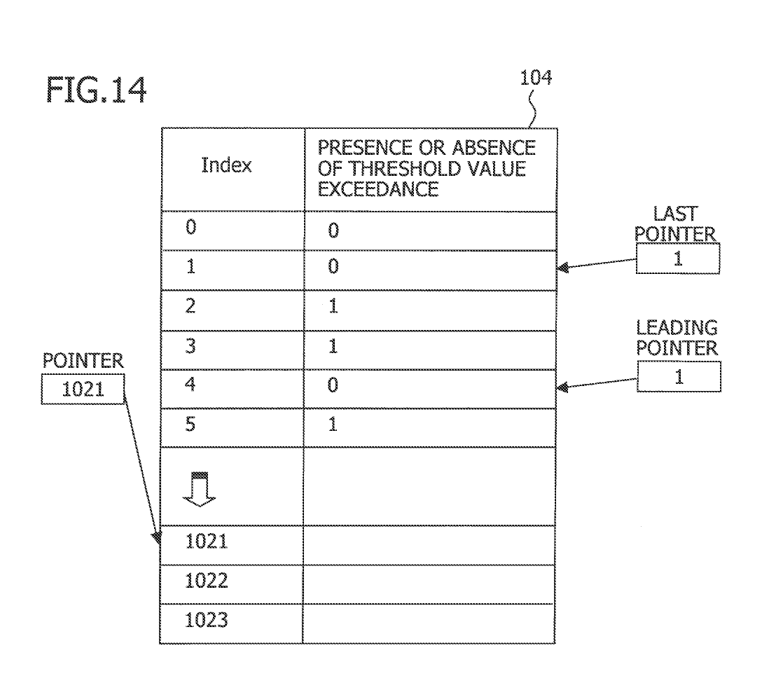

FIG. 14 is a diagram illustrating an example of the threshold value management table 104. In the threshold value management table 104, an index is assigned to each time of measurement of the round-trip time, and a flag that indicates whether or not the difference exceeds the second threshold value is written into each of the indexes. In the index, for example, the pointer that indicates the index is advanced one by one each time the jitter reception side measurement unit 103 receives an ICMP Echo Reply message. Alternatively, the jitter reception side measurement unit 103 extracts an index that is included in the ICMP Echo Reply message. In addition, for example, the jitter reception side measurement unit 103 sequentially stores “1” in a corresponding entry of “presence or absence of the threshold value exceedance” when the calculated difference (or round-trip time) exceeds the second threshold value, and stores “0” in the corresponding entry of “presence or absence of the threshold value exceedance” when the calculated difference does not exceed the second threshold value.

In addition, the jitter reception side measurement unit 103 writes the result that indicates whether or not the difference exceeds the threshold value, into the threshold value management table 104, updates the pointer (S23), and terminates the processing (S24). The jitter reception side measurement unit 103 receives, for example, an ICMP Echo Reply message periodically, and the processing is executed from S20 again when the jitter reception side measurement unit 103 receives the message.

By the above-described processing, the presence or absence of the second threshold value exceedance of a portion of the number of times of measurement is stored in the threshold value management table 104. In addition, a quality state of the wireless WAN line is determined on the basis of the threshold value management table 104.

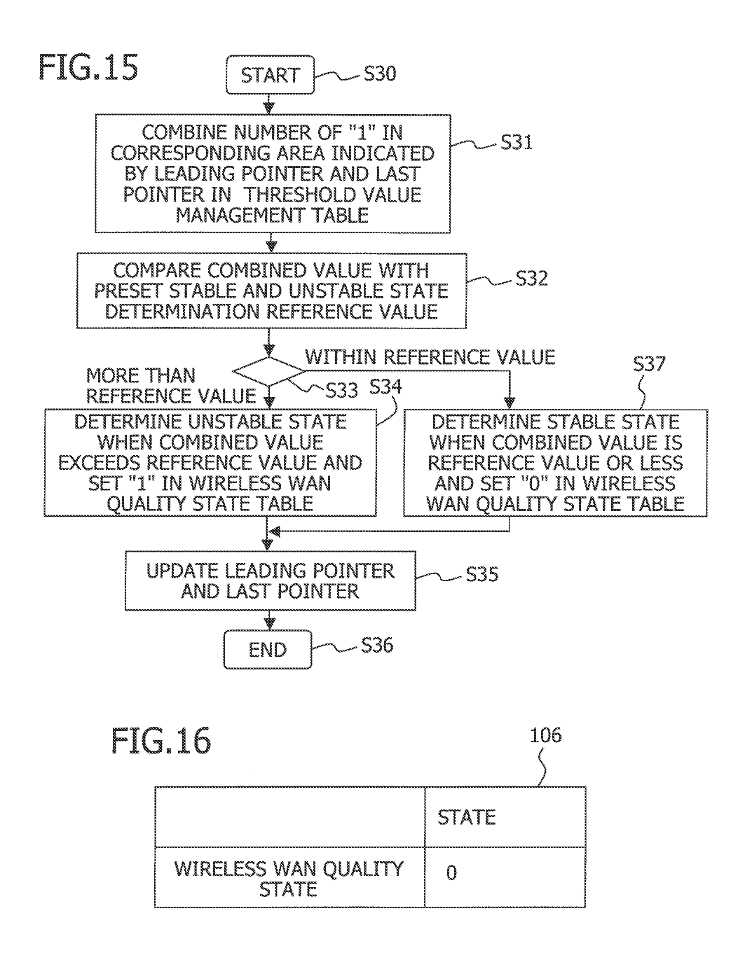

FIG. 15 is a flowchart illustrating an example of the determination processing of a quality state of the wireless WAN line. The threshold value exceedance detection unit 105 performs the determination, for example, on the basis of the number of times of occurrence of second threshold value exceedance that are stored in the threshold value management table 104.

When the threshold value exceedance detection unit 105 starts the processing (S30), the threshold value exceedance detection unit 105 combines the number of pieces of “1” in a corresponding area that is indicated by the leading pointer and the last pointer in the threshold value management table 104 (S31). For example, as illustrated in FIG. 14, the threshold value exceedance detection unit 105 calculates the number of times of occurrence of the second threshold value exceedance in a certain time (or the certain number of times) in the threshold value management table 104.

After that, the threshold value exceedance detection unit 105 compares the combined value with a stable/unstable state determination reference value (hereinafter referred to as state determination reference value) (S32). The state determination reference value can be set, for example, at “3”, etc., and is stored in a memory of the threshold value exceedance detection unit 105, another memory, etc. beforehand.

In addition, the threshold value exceedance detection unit 105 determines that the wireless WAN line is the unstable state when the combined value exceeds the reference value (“more than the reference value” in S33), and sets (or writes) a flag (for example, “1”) that indicates the wireless WAN line is the unstable state, into the wireless WAN quality state table 106 (S34).

FIG. 16 is a diagram illustrating an example of the wireless WAN quality state table 106. The wireless WAN quality state table 106 is a table that stores a quality state of the wireless WAN line that is the main line, and for example, in the wireless WAN quality state table 106, “1” indicates the unstable state and “0” indicates the stable state.

The threshold value exceedance detection unit 105 determines that, for example, the wireless WAN line is in the unstable state because delay occurs in the wireless WAN line when the number of times in which the round-trip time of the ICMP Echo message exceeds the second threshold value in the certain time period exceeds the state determination reference value.

On the other hand, the threshold value exceedance detection unit 105 determines that the wireless WAN line is in the stable state when the combined value is within the state determination reference value (“within reference value” in S33). In addition, the threshold value exceedance detection unit 105 sets (or writes) a flag (for example, “0”) that indicates that the wireless WAN line is in the stable state, to the wireless WAN quality state table 106 (S37).

The threshold value exceedance detection unit 105 determines that, for example, the wireless WAN line is in the stable state when the number of times in which the round-trip time of the ICMP Echo message exceeds the second threshold value in the certain time period is less than the state determination reference value.

In the example of the wireless WAN quality state table 106 illustrated in FIG. 16, it is determined that the wireless WAN line is in the stable state, and “0” is stored. It is noted that, in the wireless WAN quality state table 106, for example, “0” may indicate the unstable state, and “1” may indicate the stable state.

When the threshold value exceedance detection unit 105 terminates the processing of S34 and S37, the threshold value exceedance detection unit 105 updates the leading pointer and the last pointer (S35). For example, the threshold value exceedance detection unit 105 performs the update by advancing the respective leading pointer and last pointer of the threshold value management table 104 by one.

In addition, the threshold value exceedance detection unit 105 terminates the processing (S36). It is noted that, the threshold value exceedance detection unit 105 proceeds to S30 again, and can repeat the above-described processing on the basis of the updated leading pointer and last pointer.

As described above, the router apparatus 100 measures a quality state of the wireless WAN line that is the main line, and can hold information on whether the wireless WAN line is in the stable state or the unstable state.

<2. Setting Processing of the Switching Protection Time T1 and the Switching Back Protection Time T2>

The router apparatus 100 can set the switching protection time T1 and the switching back protection time T2 on the basis of the quality state of the wireless WAN line. An operation example of the setting processing of the two protection times T1 and T2 is described below with reference to FIGS. 17 to 18C.

FIG. 17, out of FIGS. 17 to 18C, is a flowchart illustrating the operation example of the setting processing of the switching protection time T1 and the switching back protection time T2. The setting processing of the two protection times T1 and T2 is executed, for example, by the wireless WAN line state detection unit 107.

When the wireless WAN line state detection unit 107 starts the processing (S40), the wireless WAN line state detection unit 107 reads a register of the wireless WAN line termination unit 102 (S41). In the register of the wireless WAN line termination unit 102, as described above, for example, information that indicates whether or not the wireless WAN line is in the communication interruption state due to occurrence of a line failure in the wireless WAN line, information that indicates whether or not the wireless WAN line is in a state in which recovery from the line failure occurs, or information that indicates whether or not the wireless WAN line is in a state in which the communication can be performed is stored. On the basis of such information that is stored in the register, the wireless WAN line state detection unit 107 can detect line disconnection due to a line failure, detect recovery from the line failure, or detect that both of the line disconnection and recovery do not occur (or the state in which the communication can be performed). It is noted that the wireless WAN line termination unit 102 can constantly monitor that such a state of the wireless WAN line and write the latest monitoring result into the register.

When the line the wireless WAN line state detection unit 107 detects disconnection (or line failure) on the basis of the register (“line disconnection is detected” in S42), the wireless WAN line state detection unit 107 execute the processing of setting the switching protection time T1 (S44 to S52). In addition, when the line the wireless WAN line state detection unit 107 detects recovery from a line failure on the basis of the register (“line recovery is detected” in S42), the wireless WAN line state detection unit 107 executes the processing of setting the switching back protection time T2 (S54 to S62). In addition, when the line the wireless WAN line state detection unit 107 does not detect both of the disconnection and recovery (“undetected” S42), the wireless WAN line state detection unit 107 terminates the processing without setting the protection times T1 and T2 in particular (S43) because the wireless WAN line is in the state in which the communication can be performed.

The setting processing of the switching protection time T1 is, for example, executed as described below. That is, when the wireless WAN line state detection unit 107 detects line disconnection (or line failure), the wireless WAN line state detection unit 107 sets a flag (for example, “1”) that indicates the line disconnection to the line state table 108 (S44). FIG. 18A is a diagram illustrating an example of the line state table 108. For example, “1” indicates the line disconnection (or line failure) state, and “0” indicates the line connection state. Here, “1” and “0” may be switched. In the line state table 108, the latest state of the wireless WAN line (the line disconnection state or the recovery state of the wireless WAN line) is stored, similar to the register of the wireless WAN line termination unit 102.

After that, the wireless WAN line state detection unit 107 reads the timer table 111 and determines whether the switching timer management unit 112 or the switching back timer management unit 120 is being activated (S45). Here, the two timer management units 112 and 120 manage elapsed times of the set protection times T1 and T2 and counts the protection times T1 and T2. In the operation, the two timer management units 112 and 120 prioritize the count operation when the two timer management units 112 and 120 perform the count operation, and store whether or not the operation is performed, in the timer table 111. FIG. 18B is a diagram illustrating an example of the timer table 111, and for example, the wireless WAN line state detection unit 107 can determine whether or not the two timer management units 112 and 120 are being activated, on the basis of the timer table 111 because “timer activation state” corresponds to “1” when the two timer management units 112 and 120 operate.

Returning to FIG. 17, when both of or one of the two timer management units 112 and 120 is being activated (“during activation” in S46), the wireless WAN line state detection unit 107 terminates the processing (S47) in order to prioritize the operation of the unit that is being activated. It is noted that, the wireless WAN line state detection unit 107 can also terminate the processing when both of the two timer management units 112 and 120 are being activated, and can also terminate the processing when one of the two timer management units 112 and 120 is being activated.

In addition, when the two timer management units are not activated (“not activated” in S46), the wireless WAN line state detection unit 107 reads the wireless WAN quality state table 106 and determines whether the wireless WAN line is in the stable state or the unstable state (S48). For example, the wireless WAN line state detection unit 107 can read a quality state that is stored in the wireless WAN quality state table 106, through the switching timer management unit 112.

In addition, when the wireless WAN line is in the stable state (“stable state” in S49), the wireless WAN line state detection unit 107 sets the switching protection time T1 in the stable state, as a timer value of the switching protection time T1 in the timer table 111 (S50).

For example, the switching protection time T1 in the stable state is stored in the protection time table 110. FIG. 18C is a diagram illustrating an example of the protection time table 110. In the protection time table 110, times of the switching protection time T1 and the switching back protection time T2 are stored depending on the stable state or the unstable state. The times can be input from the outside through the command input unit 132 and can be stored in the protection time table 110 by the protection time registration command processing unit 109. The processing is described later. As illustrated in FIG. 18C, in the switching protection time T1, as described in FIG. 3A, etc., the switching protection time T1 in the stable state is longer than the switching protection time T1 in the unstable state. In the processing (S50), the wireless WAN line state detection unit 107 reads a value (for example, 100sec) from “switching protection time (T1) setting value” in “stable state” of the protection time table 110. In addition, the wireless WAN line state detection unit 107 stores the protection time T1 in the item of “timer value” in “for switching protection time (T1) timer value” in the timer table 111.

In addition, when the wireless WAN line is in the unstable state (“unstable state” in S49), the wireless WAN line state detection unit 107 sets the switching protection time T1 in the unstable state, as the timer value of the switching protection time T1 in the timer table 111 (S53). For example, the wireless WAN line state detection unit 107 reads a value (for example, 1 sec) from “switching protection time (T1) setting value” in “unstable state” of the protection time table 110. In addition, the wireless WAN line state detection unit 107 stores the corresponding protection time T1 in the item of “timer value” in “for switching protection time (T1) timer value” of the timer table 111.

When the pieces of setting of the switching protection time T1 in the timer table 111 is completed (when the pieces of processing in S50 and S53 are completed), the wireless WAN line state detection unit 107 activates the switching timer management unit 112 (S51). As described above, the switching timer management unit 112 operates, for example, on the basis of an instruction from the wireless WAN line state detection unit 107. An operation example of the switching timer management unit 112 is described later.

In addition, the wireless WAN line state detection unit 107 terminates a series of pieces of setting processing of the switching protection time T1 (S52).

In addition, the setting processing of the switching back protection time T2 (S54 to S62) is executed, for example, as described below. That is, when the wireless WAN line state detection unit 107 detects line recovery (“line recovery is detected” in S42), the wireless WAN line state detection unit 107 sets “0” in the line state table 108 and stores the state in which the wireless WAN line is recovered from the line failure and the connection can be performed (S54).

After that, the wireless WAN line state detection unit 107 reads the timer table 111 and determines whether or not the two timer management units 112 and 120 are being activated (S55), and terminates the processing (S57) when both of or one of the timer management units 112 and 120 is being activated (“during activation” in S56) in order to prioritize the operations of the timer management units 112 and 120 that are being activated. In addition, the wireless WAN line state detection unit 107 reads the wireless WAN quality state table 106 and determines whether the wireless WAN line is in the stable state or the unstable state (S58) when both of or one of the timer management units 112 and 120 is not activated (“not activated” in S56).

In addition, when the wireless WAN line is in the stable state (“stable state” in S59), the wireless WAN line state detection unit 107 sets the switching back protection time T2 in the stable state, as a timer value of the switching back protection time T2 in the timer table 111 (S60). In addition, when the wireless WAN line is in the unstable state (“unstable state” in S59), the wireless WAN line state detection unit 107 sets the switching back protection time T2 in the unstable state, as the timer value of the switching back protection time T2 in the timer table 111 (S63).

As described in FIGS. 6A to 7B, the switching back protection time T2 in the unstable state is longer than the switching back protection time T2 in the stable state. Regarding the switching back protection time T2, in the protection time table 110, the switching back protection time T2 in the unstable state and the switching back protection time T2 in the stable state are stored by the protection time registration command processing unit 109. In addition, the wireless WAN line state detection unit 107 reads the switching back protection time T2 in the stable state or unstable state, from the protection time table 110, and can store the switching back protection time T2 in the timer table 111. The wireless WAN line state detection unit 107 store the switching back time T2 in the stable state or unstable state, which is read from the protection time table 110, in the item of “timer value” in “for switching back protection time (T2) timer value” in the timer table 111 illustrated in FIG. 18B.

When the processing of S60 or S63 ends, the wireless WAN line state detection unit 107 activates the switching back timer management unit 120 (S61). The switching back timer management unit 120 can also operate by an instruction from the wireless WAN line state detection unit 107.

In addition, a series of pieces of processing ends (S62).

By the above-described processing, in the router apparatus 100, the switching protection time T1 and the switching back protection time T2 depending on the quality state of the wireless WAN line are set or stored, and the switching protection time T1 is counted by a timer in the switching timer management unit 112. In addition, the switching back protection time T2 is counted by a timer in the switching back timer management unit 120. The count processing and processing subsequent to such count processing are described below.

<3. Count Processing, Switching Processing, and Switching Back Processing>

The count processing and switching processing are described below with reference to FIGS. 19 to 21. FIG. 19 is a flowchart illustrating an example of the count processing and the switching processing when the switching protection time T1 is set. For example, the processing is executed by the switching timer management unit 112.

When the switching timer management unit 112 starts the processing (S70), the switching timer management unit 112 subtracts a timer cycle portion from the timer value of the switching protection time T1 in the timer table 111 (S71). The switching timer management unit 112 starts the operation, for example, by an instruction from the wireless WAN line state detection unit 107, and then, for example, can operate for each timer cycle such as 10 msec. The switching timer management unit 112 subtracts, for example, a timer cycle portion from the timer value in the timer table 111, to which the switching protection time T1 is set each time the switching timer management unit 112 operates. It is noted that, when the switching timer management unit 112 starts the operation, the switching timer management unit 112 stores a flag (for example, “1”) that indicates the switching timer management unit 112 operates, in the item of “timer activation state” in the timer table 111.

In addition, the switching timer management unit 112 determines whether or not the set switching protection time T1 elapses by determining whether or not the subtracted result is “0” (S72). When the timer value in the timer table 111 is not “0” as a result of the subtraction (“≠0” in S72), the switching timer management unit 112 proceeds to the processing of S71 again because the switching protection time T1 does not elapse yet.

When the subtracted timer value is “0” (“=0 (time out)” in S72), the switching timer management unit 112 reads the line state table 108 and determines the line state (S73). For example, the switching timer management unit 112 reads the line state of the wireless WAN line from the line state table 108 after the switching protection time T1 elapses, and determines the line state after the switching protection time T1 elapses. For example, the switching timer management unit 112 can read out information on the line state from the line state table 108 through the wireless WAN line state detection unit 107.

When the line state that is read from the line state table 108 is the disconnection state (or line failure) (“disconnection state” in S74), the switching timer management unit 112 performs the switching to the wired WAN line that is the sub line because the wireless WAN line that is the main line is in the disconnection state (or line failure). That is, when the wireless WAN line is in the disconnection state (or line failure), the switching timer management unit 112 outputs a connection instruction to the wired line termination unit 130 (S75). The wired line termination unit 130 can execute, for example, connection processing, etc. of performing connection to the wired WAN line when the wired line termination unit 130 receives the connection instruction.

In addition, the switching timer management unit 112 accesses the routing table 113 and sets an entry in which the wireless WAN line termination unit 102 is an output interface, invalid (S76).

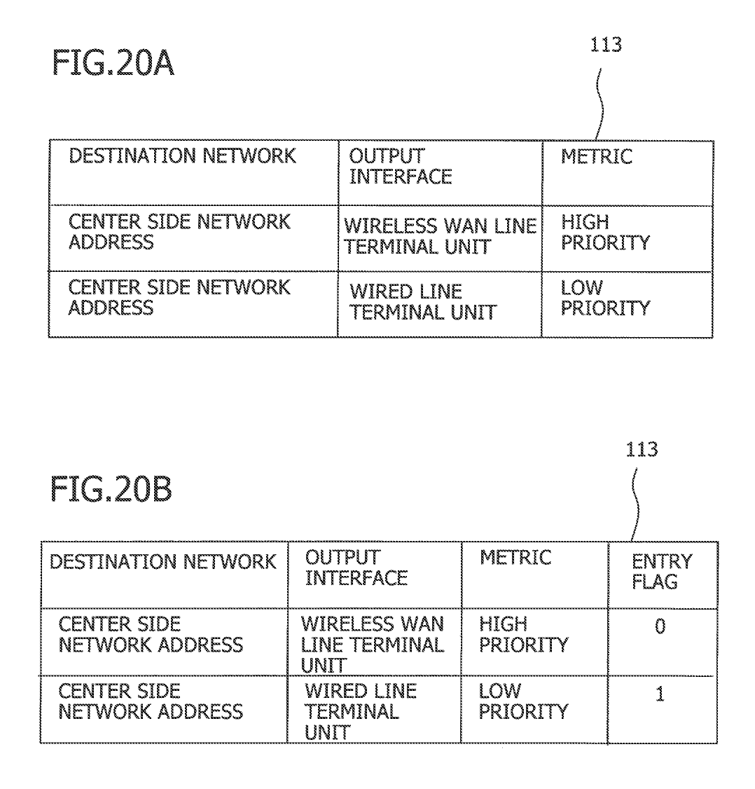

FIG. 20A is a diagram illustrating an example of the routing table 113. The routing table 113 is, for example, a table that stores a path information, etc. that indicates whether data and a signal from the terminals 200-1 to 200-n, which are input to the router apparatus 100, are transmitted to the wireless WAN line that is the main line or the wired WAN line that is the sub line.

For example, the forwarding unit 140 can transmit the data and signal that are transmitted from the terminals 200-1 to 200-n to the wireless WAN line or the wired WAN line, in accordance with the path information that are stored in the routing table 113. For example, the forwarding unit 140 can transmit data and a signal the destination of which is “center side network addresses”, to an output interface in which “metric” is “high priority” in the routing table 140. Therefore, there is no transmission destination having high priority when an entry of “wireless WAN line termination unit” that is the output interface in which “high priority” is set in the routing table 113 is deleted. Therefore, the forwarding unit 140 can transmit a transmission destination of the data and signal in which the destination is “center side network addresses”, to “wired line termination unit”.

Returning to FIG. 19, in addition, when the line state of the wireless WAN line is the connection state in which the communication can be performed (or when a line failure does not occur, that is, “connection states” in S74), the switching timer management unit 112 proceeds to the processing of S77 without executing the processing of S75 and S76.

When the processing of S76 ends, and the wireless WAN line is in “connection states” in S74, the switching timer management unit 112 sets the timer activation state of the switching protection time T1 in the timer table 111 at “not activated” (S77). The switching timer management unit 112 sets, for example, “timer activation state” in the timer table 111 at “0” and stores “not activated” because the switching protection time T1 elapses, and the processing, etc. on the routing table 113 is executed.

In addition, the switching timer management unit 112 terminates a series of pieces of processing (S78).

By the above-described processing, the switching from the main line to the sub line is performed when the line failure in the wireless WAN line continues after the switching protection time T1 elapses. In addition, the router apparatus 100 can transmit the data and signal that are transmitted from the terminals 200-1 to 200-n, etc., to the wired WAN line that is the sub line.

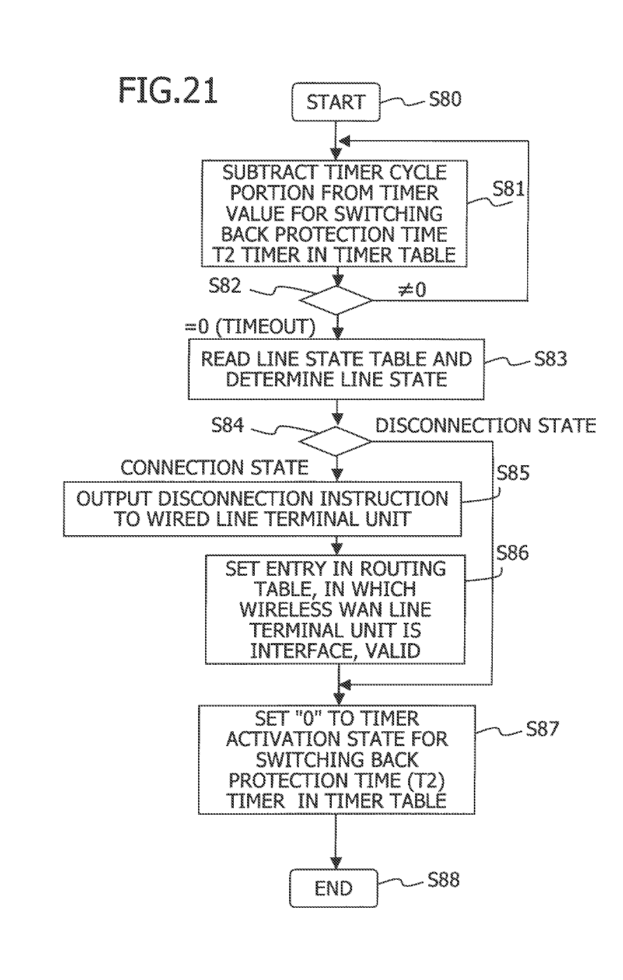

The count processing and the switching back processing of the switching back protection time T2 are described below. FIG. 21 is a flowchart illustrating an example of such processing. For example, the processing is executed by the switching back timer management unit 120.

When the switching back timer management unit 120 starts the processing (S80), the switching back timer management unit 120 subtracts a timer cycle portion from the timer value of the switching back protection time T2, which is stored in the timer table 111 (S81). The switching back timer management unit 120 starts the operation, for example, by an instruction from the wireless WAN line state detection unit 107, and operates for each of the timer cycles such as 10 msec. Therefore, the switching back timer management unit 120 subtracts the timer cycle portion from the switching back protection time T2 that is stored as “timer value” in the timer table 111, for each of the operations.

In addition, when the subtracted timer value is not “0” (“≠0” in S81), the switching back timer management unit 120 waits until the subtracted timer value becomes “0” (loop in a case of “≠” in S81).

On the other hand, when the subtracted timer value becomes “0” (“=0 (time out)” in S81, the switching back timer management unit 120 determines the line state on the basis of the line state table 108 (S83). In the line state table 108, the latest line state of the wireless WAN line is stored, and the switching back timer management unit 120 reads the line state from the line state table 108 after the switching back protection time T2 elapses, similar to the switching timer management unit 112. In the case of the switching back, the switching back timer management unit 120 determines the line state of the wireless WAN line that is the main line as the line state, similar to the case of the switching (S73). The switching back timer management unit 120 can also read information on the line state by accessing the line state table 108 through the wireless WAN line state detection unit 107.

When the line state of the wireless WAN line is the connection state in which the communication can be performed (or when a line failure does not occur, that is, “connection states” in S84), the switching back timer management unit 120 outputs a disconnection instruction to the wired line termination unit 130 in order to perform the switching back to the main line from the sub line (S85). The wired line termination unit 130 executes, for example, a sequence of pieces of disconnection processing on the wired WAN line in response to the disconnection instruction, and can perform disconnection of the wired WAN line in order not to perform the communication through the wired WAN line.

After that, the switching back timer management unit 120 sets the entry in the routing table 113, in which the wireless WAN line termination unit 102 is the output interface, valid (S86). In the switching processing, the entry of “wireless WAN line termination unit” that corresponds to the metric having “high priority” in the routing table 113 is deleted, however in the switching back processing, for example, the deleted entry is rewritten. As a result, as the metric of “high priority”, the output interface of “wireless WAN line termination unit” becomes valid, so that the router apparatus 100 can transmit the data and signal that are transmitted from the terminals 200-1 to 200-n, from the wired WAN line that is the sub line to the wireless WAN line.

It is noted that, for example, as illustrated in FIG. 20B, the routing table 113 can provide the item of “entry flag”, and for example, determines whether or not “high priority” metric is valid. For example, the router apparatus 100 outputs the data, etc. to the corresponding output interface when “entry flag” of the high priority metric is “1”. In addition, when “entry flag” of the high priority metric is “0”, the router apparatus 100 can output the data, etc. to the output interface that corresponds to a low priority metric in which “entry flag” is “1”. In this case, for example, it is indicated that output to the corresponding output interface cannot be performed when “entry flag” of the low priority metric is “0”. The writing of a flag into “entry flag” can be performed, for example, by the switching timer management unit 112 or the switching back timer management unit 120.

When the wireless WAN line is in the disconnection state (or when a line failure occurs, that is, “disconnection state” in S84), or after the processing of S86 ends, the switching back timer management unit 120 sets the timer activation state of the switching back protection time T2 in the timer table 111, at “not activated” (S87). For example, the switching back timer management unit 120 stores “0” in “timer activation state” in the timer table 111 (for example, FIG. 18B). When the line failure of the wireless WAN line that is the main line continues, the connection to the sub line is continued because the router apparatus 100 cannot perform the processing of switching back.

In addition, the switching back timer management unit 120 terminates a series of pieces of processing (S88).

By the above-described processing, when recovery from the line failure in the wireless WAN line that is the main line occurs and the state becomes the state in which the communication can be performed after the switching back protection time T2 elapses, the switching back to the main line from the wired WAN line that is the sub line is performed. As a result, the router apparatus 100 can transmit data, a signal, etc. that are transmitted from the terminals 200-1 to 200-n, to the wireless WAN line that is the main line.

<4. Other Processing>

Other processing is described below. First, wired line state detection processing of detecting a state of the wired WAN line is described, and protection time registration processing by the protection time registration command processing unit 109 is described next.

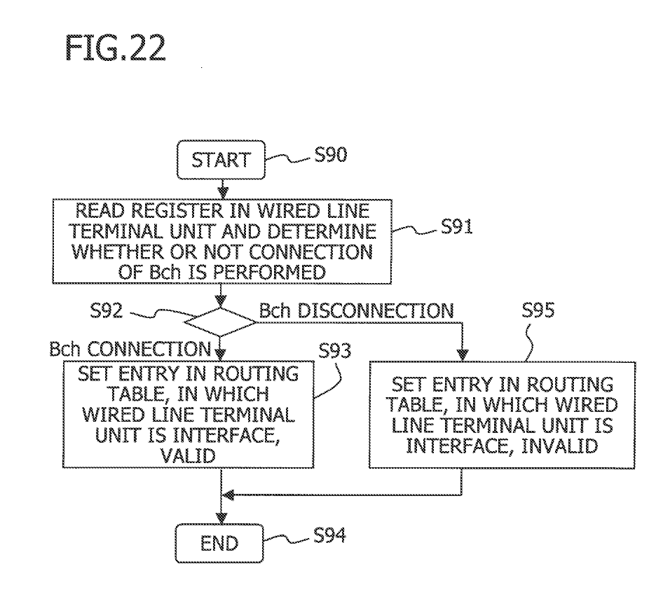

FIG. 22 is a flowchart illustrating an operation example of the wired line state detection processing. For example, the processing is executed by the wired line state detection unit 131.

When the wired line state detection unit 131 starts the wired line state detection processing (S90), the wired line state detection unit 131 reads a register of the wired line termination unit 130 and determines whether or not connection of the Bch is performed (S91). For example, the wired line state detection unit 131 starts the processing by an interrupt instruction from the wired line termination unit 130. In addition, in the register of the wired line termination unit 130, information that indicates whether or not connection of the wired WAN line is performed is stored, and in the embodiment, connection information of the B channel for communication in the ISDN is stored in the register. For example, in the register, the wired line termination unit 130 stores information that indicates that connection of the B channel can be performed when connection of a connector of the B channel, which is used to transmission or reception is performed and stores information, etc. that indicates the connection of the B channel is not performed when connection of the connector is not performed. The wired line state detection unit 131 determines whether or not the connection of the B channel is performed on the basis of such connection information of the B channel, which is stored in the register.

In addition, when the wired line state detection unit 131 determines that the connection of the B channel is performed (“Bch connection” in S92), the wired line state detection unit 131 sets the entry in the routing table 113, in which the wired line termination unit 130 is the interface, valid (S93). For example, in the routing table 113 in FIG. 20A, in the entry of “output interface” in which the destination is “center side network addresses” (=the center side router apparatus 400), and the metric is “low priority”, information on “wired line termination unit” is stored. The wired line state detection unit 131 may not execute the processing in particular, for example, when the entry of the wired line termination unit 130 is already stored in the corresponding entry in the routing table 113. In addition, when there is an entry of “entry flag” in the routing table 113 (for example, FIG. 20B), the wired line termination unit 130 can store a flag (for example, “1”) that indicates “valid” in the entry.

On the other hand, when the wired line state detection unit 131 determines that the connection of the B channel is not performed (“Bch disconnection” in S92), the wired line state detection unit 131 sets the entry in the routing table 113, in which the wired line termination unit 130 is the interface, invalid (S95). For example, for the routing table 113 in FIG. 20A, the information on the “valid line termination unit” is deleted from the entry of “output interface” in which the destination is “center side network addresses” and the metric is “low priority”. In addition, when there is the entry of “entry flag” in the routing table 113 (for example, FIG. 20B), the wired line state detection unit 131 can store a flag (For example, “0”) that indicates “radio” in the entry.

As described above, the wired line state detection unit 131 can store, for example, information that indicates whether or not connection to the wired line can be performed, on the basis of the connection state of the wired line, in the routing table 113.

In addition, when the wired line state detection unit 131 sets the entry in the routing table 113 valid (S93), or sets the entry in the routing table 113 invalid (S95), the wired line state detection unit 131 terminates a series of pieces of processing (S94). As described above, whether “wired line termination unit” is valid or invalid as the output interface, or whether or not transmission to the wired WAN line can be performed can be set in the routing table 113.

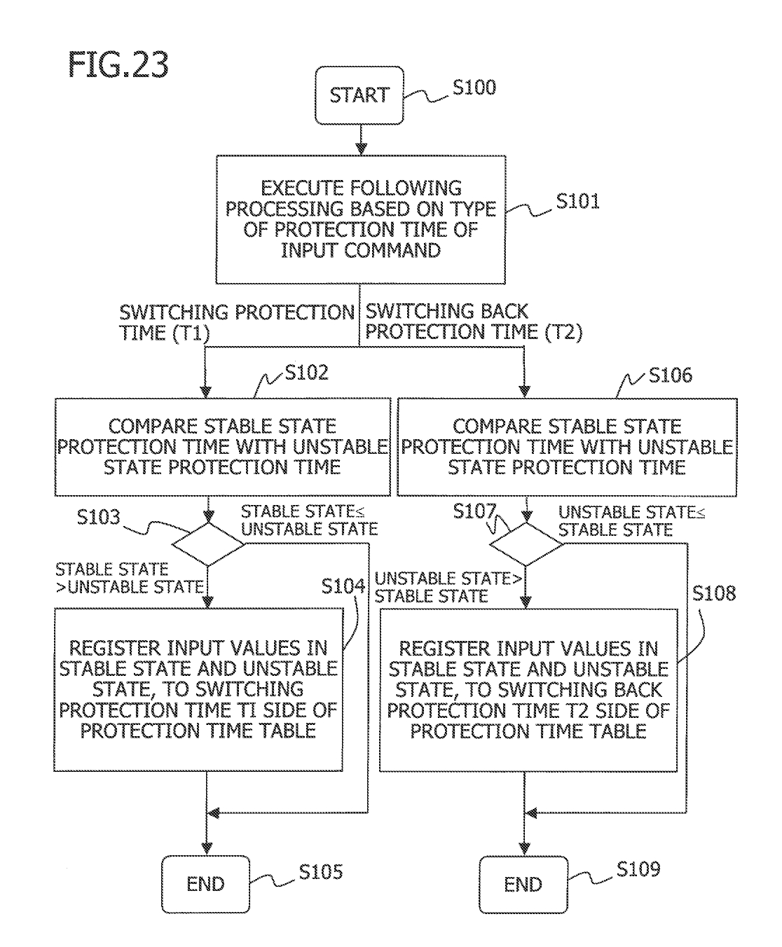

The protection time registration processing is described below. FIG. 23 is a flowchart illustrating an operation example of the protection time registration processing. For example, the protection time registration processing is processing that is executed by the protection time registration command processing unit 109, etc., and is also write processing of the two protection times T1 and T2 to the protection time table 110.

When the protection time registration command processing unit 109 starts the processing (S100), the protection time registration command processing unit 109 determines the type of the protection time of a command that is input through the command input unit 132 (S101). The command input unit 132 is connected, for example, to a keyboard, etc. of the router apparatus 100 and can input a command that is input by the keyboard. Alternatively, the command input unit 132 can also input a command from an apparatus that is connected to the communication network system 10 (for example, the center side router apparatus 400, etc.) such as the terminals 200-1 to 200-n.

The command includes, for example, a protection time type P1 in which the protection time indicates the switching protection time T1 or the switching back protection time T2. For example, the protection time indicates the switching protection time T1 when “P1=0” is satisfied, and the protection time indicates the switching back protection time T2 when “P1=1” is satisfied. In addition, the command includes, for example, a stable state protection time P2 and an unstable state protection time P3. For example, the stable state protection time P2 indicates a protection time (for example, 1 to 9999 seconds) in the case in which the wireless WAN line that is the main line is in the stable state, and the unstable state protection time P3 indicates a protection time (for example, 1 to 9999 seconds) in the case in which the wireless WAN line that is the main line is in the unstable state. The protection time registration command processing unit 109 can determine the type of a protection time on the basis of the protection time type P1 of the command that is received from the command input unit 132.

When the protection time type of the command corresponds to the switching protection time T1 (for example, P1=0), the protection time registration command processing unit 109 compares the stable state protection time P2 with the unstable state protection time P3 that are included in the command (S102).

In addition, when the stable state protection time P2 is longer than the unstable state protection time P3 (“stable state>unstable state” in S103), the protection time registration command processing unit 109 stores the stable state protection time P2 and the unstable state protection time P3 in the protection time table 110 (S104). As described in FIGS. 3A to 4B, etc., the switching protection time T1 when the wireless WAN line is in the stable state is longer than the switching protection time T1 when the wireless WAN line is in the unstable state. The registration to the protection time table 110 is performed only after the condition is satisfied. For example, when the condition is satisfied, the protection time registration command processing unit 109 registers the stable state protection time P2 to the entry of “switching protection time (T1) setting value” in “stable state” in the protection time table 110. In addition, the protection time registration command processing unit 109 registers the unstable state protection time P3 to the entry “switching protection time (T1) setting value” in “unstable state” in the protection time table 110. For example, the stable state protection time P2 and the unstable state protection time P3 that are registered to the protection time table 110 are registered as the switching protection time T1 in the stable state and the switching protection time T1 in the unstable state.

In addition, the protection time registration command processing unit 109 terminates a series of pieces of processing (S105).

On the other hand, when the stable state protection time P2 is equal to or less than the unstable state protection time P3 (“stable state≦unstable state” in S103), the protection time registration command processing unit 109 does not perform the registration to the protection time table 110. After that, the protection time registration command processing unit 109 terminates a series of pieces of processing (S105).

In addition, when the protection time type of the command is the switching back protection time T2 (for example, “P1=1”), the protection time registration command processing unit 109 compares the stable state protection time P2 with the unstable state protection time P3 that are included in the command (S106), similarly.

In addition, when the stable state protection time P2 is shorter than the unstable state protection time (“unstable state>stable state” in S107), the protection time registration command processing unit 109 stores the respective times in the protection time table 110 (S108). On the other hand, when the stable state protection time P2 is equal to or more than the unstable state protection time P3 (“unstable state≦stable state” in S107), the protection time registration command processing unit 109 does not store the respective times in the protection time table 110 and terminates a series of pieces of processing (S109).

For example, as described in FIGS. 6A to 7B, the switching back protection time T2 when the wireless WAN line is in the unstable state is longer than the switching back protection time T2 when the wireless WAN line is in the stable state. The protection time registration command processing unit 109 performs registration to the protection time table 110 only after the condition is satisfied. For example, the protection time registration command processing unit 109 stores the stable state protection time P2 in which the protection time type is the switching back protection time T2, in an entry that corresponds to “switching back protection time (T2) setting value” of “stable state” in the protection time table 110. In addition, the protection time registration command processing unit 109 stores the unstable state protection time P3 in which the protection time type is the switching back protection time T2, in an entry of “switching back protection time (T2) setting value” of “unstable state” in the protection time table 110.

In addition, the protection time registration command processing unit 109 terminates a series of pieces of processing (S109).

### Other Embodiments

Other embodiments are described below. In the second embodiment, in the communication network system 10, the example of the single center side router apparatus 400 is described. To the center side network 600, the plurality of center side router apparatuses 400 may be connected. FIG. 24 illustrates an example in which two center side router apparatuses 400-1 and 400-2 are connected to the center side network 600. In this case, the center side router apparatuses 400-1 and 400-2 and the router apparatus 100 are connected to each other through the wireless WAN line that is the main line and the wired WAN line that is the sub line. In addition, the router apparatus 100 can transmit data and a signal that are transmitted from the terminals 200-1 and 200-2 through the main line, to one of or both of the center side router apparatuses 400-1 and 400-1 through the main line or the sub line. As described above, even when the plurality of center side router apparatuses 400-1 and 400-2 are connected to the center side network 600, the router apparatus 100 can change the two protection times T1 and T2 depending on the quality state of the wireless WAN line, similar to the second embodiment.

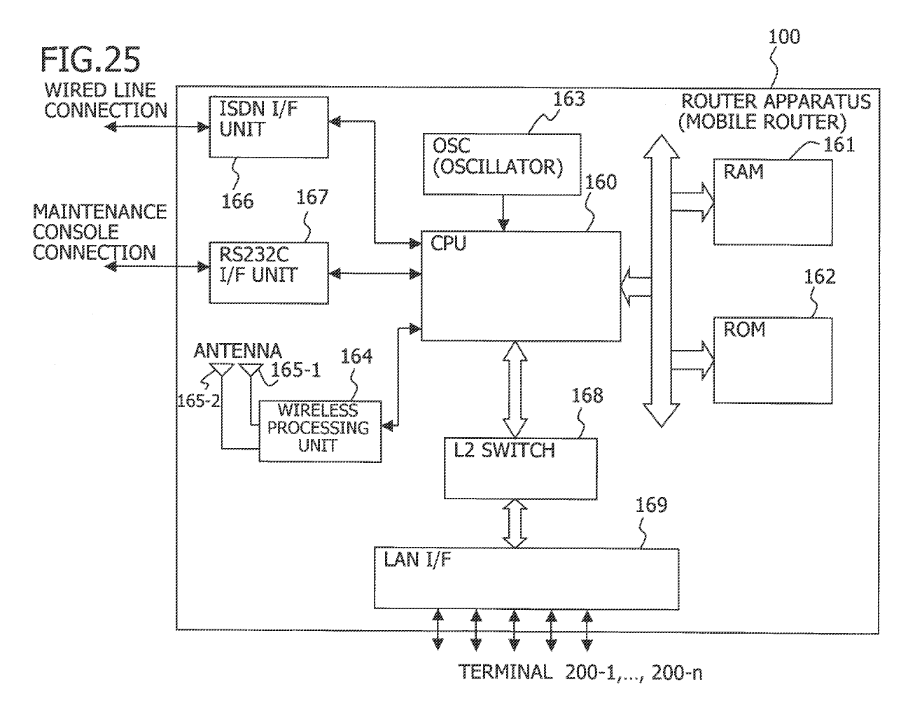

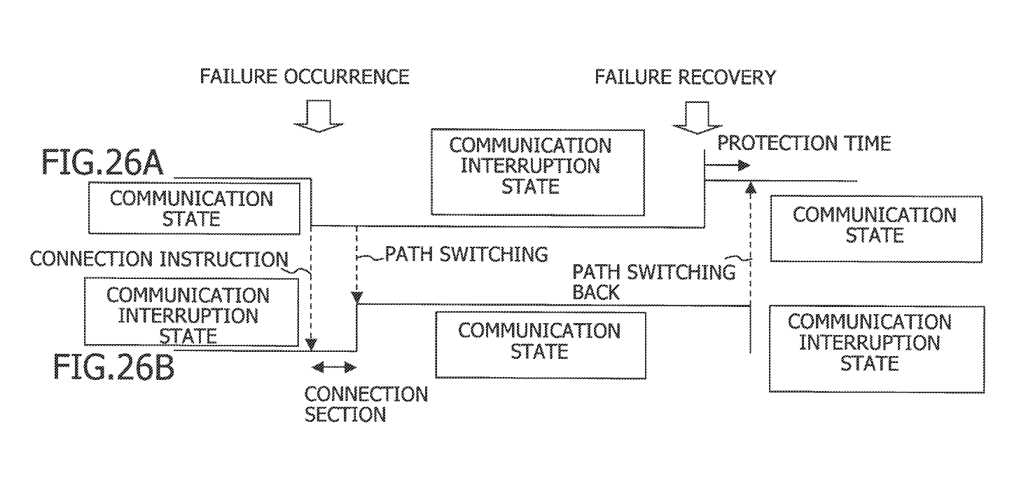

As another embodiment, the router apparatus 100 described in the second embodiment can be also realized, for example, by a configuration illustrated in FIG. 25. The router apparatus 100 includes a CPU 160, a RAM 161, a ROM 162, a OSC (oscillator) 163, a radio processing unit 164, antennas 165-1 and 165-2, an ISDN interface unit 166, an RS232C interface unit 167, an L2 switch 168, and a LAN interface 169.

For example, the CPU 160, the RAM 161, and the ROM 162 are connected to each other through a bus, and by operating the CPU 160, the RAM 161, and the ROM 162 together, for example, each function of the jitter transmission side measurement unit 101, the jitter reception side measurement unit 103, the threshold value management table 104, the threshold value exceedance detection unit 105, the wireless WAN quality state table 106, the wireless WAN line state detection unit 107, the line state table 108, the protection time registration command processing unit 109, the protection time table 110, the routing table 113, and the wired line state detection unit 131 according to the second embodiment can be realized.

In addition, by operating the CPU 160, the RAM 161, the ROM 162, and the OSC 163 together, for example, each function of the timer table 111, the switching timer management unit 112, and the switching back timer management unit 120 according to the second embodiment can be realized.

In addition, for example, the radio processing unit 164 and the antennas 165-1 and 165-2 corresponds to the wireless WAN line termination unit 102 according to the second embodiment, and the ISDN interface 166 corresponds to the wired line termination unit 130. In addition, for example, the RS232C interface 167 correspond to the command input unit 132, the L2 switch 168 corresponds to the forwarding unit 140, and the LAN interface 169 corresponds to the LAN housing unit 150.

In addition, in the above-described second embodiment, the example in which the wireless line is the main line and the wired line is the sub line is described. For example, the main line may be the wired line, and the sub line may be the wireless line. In addition, both of the main line and the sub line may be the wireless line, and both of the main line and the sub line may be the wired line. In any case, it is sufficient that the switching protection time T1 when the line state of the main line is the stable state is longer than the switching protection time T1 when the line state of the main line is the unstable state. In addition, it is sufficient that the switching back protection time T2 when the line state of the main line is the stable state is shorter than the switching back protection time T2 when the line state of the main line is the unstable state.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A router apparatus for performing communication by switching a first and second line, the router apparatus comprising:
a setting unit which sets a first protection time until the first line is switched to the second line after a line failure in the first line is detected, and a second protection time until the second line is switched to the first line after recovery from the line failure in the first line is detected, to times corresponding to a quality state of the first line, respectively; and
a line switching unit which switches the first line to the second line when the first protection time elapses and the line failure in the first line continues, or switches the second line to the first line when the second protection time elapses after the line failure in the first line is detected.

2. The router apparatus according to claim 1, wherein the setting unit sets the first protection time in which the quality state of the first line is a first state, longer than the first protection time in which the quality state of the first line is a second state.

3. The router apparatus according to claim 1, wherein the first state is a state in which a round trip time until a reply message for a message is received after the message is transmitted through the first line is not changed or is reduced, and the second state is a state in which the round trip time increases.

4. The router apparatus according to claim 1, wherein, in a first state, a round trip time until a reply message for a message is received after the message is transmitted through the first line is measured by a plurality of times, and a number of times in which the round trip time exceeds a threshold value is a state determination reference value or less, and in a second state, the number of times in which the round trip time exceeds the threshold value is more than the state determination reference value.

5. The router apparatus according to claim 1, wherein the setting unit sets the second protection time in which the quality state of the first line is a first state shorter than the first protection time in which the quality state of the first line is a second state.

6. The router apparatus according to claim 5, wherein the first state is a state in which a round trip time until a reply message for a message is received after the message is transmitted through the first line is not changed or is reduced, and the second state is a state in which the round trip time increases.

7. The router apparatus according to claim 5, wherein in the first state, a round trip time until a reply message for a message is received after the message is transmitted through the first line is measured by a plurality of times, and a number of times in which the round trip time exceeds a threshold value is a state determination reference value or less, and in the second state, the number of times in which the round trip time exceeds the threshold value is more than the state determination reference value.

8. The router apparatus according to claim 1, wherein
the setting unit includes a protection time table that stores the first and second protection times, and
the setting unit stores the first protection times of a first and second states in the protection time table, when the first protection time in which the quality state of the first line is the first state is longer than the first protection time in which the quality state of the first line is the second state, and stores the second protection times of the first and second states in the protection time table, when the second protection time in which the quality states of the first line is the first state is shorter than the first protection time in which quality state of the first line is the second state.

9. The router apparatus according to claim 1, wherein
the setting unit includes a timer table that stores the first or second protection time, and
the setting unit sets the first or second protection time by storing in the timer table the first protection time corresponding to the quality state of the first line when a line failure in the first line is detected, or storing in the timer table the second protection time corresponding to the quality state of the first line when recovery from the line failure in the first line is detected.

10. The router apparatus according to claim 9, wherein the line switching unit determines whether the first or second protection time elapses or not, based on the first or second protection time stored in the timer table.

11. The router apparatus according to claim 1, wherein the first line is a wireless line and the second line a wired line.

12. The router apparatus according to claim 1, wherein the first line is a wireless line or a wired line, and the second line is a wireless line or a wired line.

13. A line switching method in a router apparatus for performing communication by switching a first and second lines, the line switching method comprising:
setting a first protection time until the first line is switched to the second line after a line failure in the first line is detected, and a second protection time until the second line is switched to the first line after recovery from the line failure in the first line is detected, to times corresponding to a quality state of the first line, respectively, by a setting unit; and
switching the first line to the second line when the first protection time elapses and the line failure in the first line continues, or switching the second line to the first line when the second protection time elapses after the line failure in the first line is detected, by a line switching unit.
